(19) United States
(12) Patent Application Publication
(10) Pub. No.: US 2018/0160679 A1
(43) Pub. Date: Jun. 14, 2018

(54) PROCESS FOR TREATING PERENNIAL PLANT WOOD DISEASES

(71) Applicant: PHYTEUROP S.A., LEVALLOIS PERRET CEDEX (FR)

(72) Inventors: Philippe CROZIER, LYON (FR); Antoine PARIS, DOUE LA FONTAINE (FR); Philippe KUENEMANN, SATROUVILLE (FR)

(21) Appl. No.: 15/580,292

(22) PCT Filed: Jun. 15, 2016
(86) PCT No.: PCT/FR2016/051453

§ 371 Date: Dec. 7, 2017

(30) Foreign Application Priority Data
Jun. 19, 2015 (FR) 15 55650

(51) Int. Cl. A01N 25/30; A01N 37/34; A01N 43/653; A01N 25/02

(52) U.S. Cl. CPC A01N 25/30; A01N 25/02; A01N 43/653; A01N 37/34

(57) ABSTRACT

Disclosed is a fungicide composition in the form of a concentrated suspension including at least two active ingredients in the form of solid particles, at least one bark penetrating agent, the median diameter D₅₀ of the solid particles being from 0.1 to 1 μm, the composition having a depth of penetration of at least one of the active ingredients into the wood, in particular the ligneous parts of at least 0.1 mm, its use for treating diseases of the wood, in particular of the ligneous parts of perennial plants and a method for treating perennial plants.

The present invention relates to the treatment of diseases of the wood of perennial plants, in particular of the ligneous parts of perennial plants, in particular of fruit trees and grapevines.

There are numerous pathogens (viruses, bacteria, fungi and parasites) that are responsible for diseases of fruit trees and grapevines, attacking all or part of the fruit tree or grapevine: roots, fruit, leaves and wood (ligneous parts).

These pathogens cause considerable damage in plantations, reducing the quantitative and qualitative production potential of these crops.

Among the diseases that affect perennial plants, those affecting the leaves and the fruit, such as mildew, can be treated effectively. In fact, the structure of these parts of the plant allows effective diffusion of the active ingredient within the leaves and fruit.

The diseases of fungal origin currently represent a real scourge in arboriculture and viticulture, especially diseases affecting the wood, in particular the ligneous parts, the long-lasting element of these plants. The diseases of the wood, in particular of the ligneous parts of plants are manifested in various forms with variable severity, such as loss of vigour of the plant, reflected in weakened vegetation and less maturation, or necrosis of all or part of the plant. In certain cases, no obvious symptom allows the presence of the disease in the plant to be detected.

In the ligneous parts, these diseases are reflected in various aspects of degradation, ending with the formation of cankers and necroses.

Many of the diseases affecting grapevines or fruit trees are ubiquitous and occur in the grape varieties and plantations of fruit trees on all the continents. The commonest diseases of the wood of the grapevine are Eutypiosis, Esca, black dead arm (BDA) and Petri disease. The commonest diseases of the wood of fruit trees are crown gall, European canker and fire blight.

Currently there are very few fungicide treatments dedicated to the treatment of diseases of the wood of fruit trees and grapevines. A formulation marketed in France contains a fungal strain capable of controlling diseases of the wood of the grapevine. However, a drawback of such biological solutions is that they have variable efficacy, lower efficacy and limited stability over time compared to chemical solutions.

In contrast to diseases affecting the parts of a plant such as the leaves and fruit, diseases of the wood are in fact much more difficult to treat because the active ingredients need to penetrate to the interior of the wood where the pathogens are located. In the absence of treatment in depth, the fungus is not eliminated and there can be a resurgence of the disease and/or its spread in a plantation, jeopardizing the continuity of the viticulture and/or arboriculture assets.

There is therefore a need for a fungicide composition useful in the treatment of diseases of the wood, in particular diseases of the wood of fruit trees and grapevines, capable of delivering the active agents against the fungi deep into the wood, in particular the ligneous parts, sufficient to prevent and/or treat the symptoms associated with these fungi.

A first aspect of the present invention is a fungicide composition in the form of a concentrated suspension capable of delivering the active ingredients in the form of micronized solid particles that it contains within the wood, in particular the ligneous parts of a plant.

A second aspect of the present invention is the use of a fungicide composition in the form of a concentrated suspension capable of delivering the active ingredients that it contains into the wood, in particular the ligneous parts of a plant for preventing and/or treating diseases of the wood, in particular of the ligneous parts of a plant, in particular of fruit trees and grapevines.

A third aspect of the present invention is a method for preventing and/or treating diseases of the wood, in particular of the ligneous parts of a plant, in particular of fruit trees and grapevines, comprising contacting a fungicide composition in the form of a concentrated suspension or a dilute suspension comprising said fungicide composition in the form of a concentrated suspension capable of delivering the active ingredients that it contains into the wood, in particular the ligneous parts of said plant.

The present invention relates to a fungicide composition that contains two antifungal substances in the form of micronized solid particles and a compound promoting penetration of said active ingredients into the wood, in particular the ligneous parts, to a depth of at least 0.1 mm, the use thereof for preventing and/or treating diseases of the wood, in particular of the ligneous parts of a plant, as well as a method for preventing and/or treating diseases of the wood, in particular of the ligneous parts of a plant, employing said fungicide composition.

The present invention therefore relates firstly to a fungicide composition in the form of a concentrated suspension of formula (A) comprising:
at least two active ingredients in the form of solid particles, the first active ingredient being selected from the penetrating and/or systemic antifungals and the second active ingredient being selected from the contact antifungals,
at least one penetrating agent, the median diameter D₅₀ of the solid particles being from 0.1 to 1 μm, advantageously from 0.3 to 0.8 μm, in particular from 0.7 to 0.8 μm, and said composition having a depth of penetration of at least one of the active ingredients in the wood of at least 0.1 mm.

The present invention also relates to a fungicide composition in the form of a concentrated suspension of formula (I) comprising:
at least two active ingredients in the form of solid particles, the first active ingredient being selected from the penetrating and/or systemic antifungals and the second active ingredient being selected from the contact antifungals,
at least one bark penetrating agent,

the median diameter D₅₀ of the solid particles being from 0.1 to 1 μm, advantageously from 0.3 to 0.8 μm, in particular from 0.7 to 0.8 μm, and

said composition having a depth of penetration of at least one of the active ingredients into the wood, in particular the ligneous parts, of at least 0.1 mm as determined by the method consisting of preparing a composition comprising one or more active ingredients, applying said composition on the wood, in particular the ligneous parts, of a plant, taking a specimen from said plant and evaluating the presence of at least one active ingredient at a depth greater than 0.1 mm from the outer surface of the wood, in particular of the ligneous parts.

In particular, the present invention relates to a fungicide composition in the form of a concentrated suspension of formula (Ia) comprising:
at least two active ingredients in the form of solid particles, the first active ingredient being selected from the penetrating and/or systemic antifungals and the second active ingredient being selected from the contact antifungals,
at least one bark penetrating agent,

the median diameter D₅₀ of the solid particles being from 0.1 to 1 μm, advantageously from 0.3 to 0.8 μm, in particular from 0.7 to 0.8 μm, and

said composition having a depth of penetration of at least one of the active ingredients in the ligneous parts of at least 0.1 mm as determined by the method consisting of preparing a composition comprising one or more active ingredients, applying said composition on the wood, in particular the ligneous parts of a fruit tree, taking a specimen from said fruit tree and evaluating the presence of at least one active ingredient at a depth greater than 0.1 mm from the outer surface of the wood, in particular of the ligneous parts.

In particular, the present invention relates to a fungicide composition in the form of a concentrated suspension of formula (Ib) comprising:
at least two active ingredients in the form of solid particles, the first active ingredient being selected from the penetrating and/or systemic antifungals and the second active ingredient being selected from the contact antifungals,
at least one bark penetrating agent,

the median diameter D₅₀ of the solid particles being from 0.1 to 1 μm, advantageously from 0.3 to 0.8 μm, in particular from 0.7 to 0.8 μm, and

said composition having a depth of penetration of at least one of the active ingredients in the ligneous parts of at least 0.1 mm as determined by the method consisting of preparing a composition comprising one or more active ingredients, applying said composition on the wood, in particular the ligneous parts of a vine plant, taking a specimen from said vine plant and evaluating the presence of at least one active ingredient at a depth greater than 0.1 mm from the outer surface of the wood, in particular of the ligneous parts.

By “concentrated suspension” is meant, within the meaning of the present invention, a suspension of active ingredient(s) in a liquid, which can contain other dissolved ingredient(s), for use after dilution in water. Concentrated suspensions are different from aqueous emulsions, in which the active ingredient or ingredients are present in the emulsion in soluble form in droplets of organic solution. In concentrated suspensions, the solid active ingredients, which are insoluble in water, are held in suspension.

By “penetrating agent” or “bark penetrating agent” is meant, within the meaning of the present invention, a chemical compound that promotes the diffusion of at least one active ingredient into the ligneous parts of a plant. The fungicide compositions are used on the outer surface of the wood, in particular of the ligneous parts of a plant (for example by spraying) and are therefore brought into contact with the bark. The bark penetrating agent, within the meaning of the present invention, is a compound that enables the active ingredient to pass from the outer surface of the wood, in particular of the ligneous parts, into the wood, in particular the ligneous parts of the plant.

It should be noted that although the penetrating agents belong to the class of organic solvents and surfactants, not all surfactants and organic solvents possess penetrating properties.

The ability of a compound to be used as a bark penetrating agent can be determined by the experimental method consisting of preparing a composition comprising one or more active ingredients, applying the composition on the wood, in particular the ligneous parts of a cordon de Royat (Royat cordon) more than one year old, and evaluating the presence of at least one active ingredient at a depth greater than 0.1 mm from the outer surface of the wood, in particular of the ligneous parts. In particular, it is determined that a substance can be used as a penetrating agent by the method described in Example 1 of the present application.

The present invention therefore relates more particularly to a fungicide composition in the form of a concentrated suspension of formula (Ic) comprising:
at least two active ingredients in the form of solid particles, the first active ingredient being selected from the penetrating and/or systemic antifungals and the second active ingredient being selected from the contact antifungals,
at least one substance capable of leading to the penetration of an active ingredient into the ligneous parts of a plant to a depth greater than 0.1 mm from the outer surface, as determined by the method consisting of preparing a composition comprising one or more active ingredients, applying said composition on the wood, in particular the ligneous parts of a cordon de Royat of grapevines more than one year old, and evaluating the presence of at least one active ingredient at a depth greater than 0.1 mm from the outer surface of the wood, in particular of the ligneous parts of said cordon de Royat of grapevines more than one year old, in particular by the method described in Example 1 of the present application,

the median diameter D₅₀ of the solid particles being from 0.1 to 1 μm, advantageously from 0.3 to 0.8 μm, in particular from 0.7 to 0.8 μm,

said composition having a depth of penetration of at least one of the active ingredients into the wood, in particular the ligneous parts, of the cordon de Royat of grapevines more than one year old, of at least 0.1 mm.

By “contact antifungal” is meant, within the meaning of the present invention, a chemical compound that remains on the surface of the organs touched during the treatment.

By “systemic antifungal” is meant, within the meaning of the present invention, a chemical compound capable of penetrating into the plant and spreading in all or part of the plant via the vessels of the xylem and/or phloem.

By “median diameter D₅₀ of the solid particles” is meant, within the meaning of the present invention, that 50% of the total volume of the particles is less than the D₅₀ value.

For example, for a D₅₀ of 0.5 μm, 50% of the total volume of the particles have a diameter of less than 0.5 μm.

In the present invention, D₅₀ is determined with a CILAS 715 or 920 Liquide laser granulometer. Measurement is carried out under the following conditions:
Select the analysis procedure (SOP) “Ultrasound 30s”.

Enter the specimen reference (obligatory), the batch number and the operator's initials.
Click the box “Measurement while empty” (the granulometer carries out the measurement while empty).

At the end of measurement while empty, the program waits for the introduction of the specimen, it is therefore necessary to:
Press the button “Real-time signals”, to cause the indicator of concentration of product to appear (at the bottom of the table).
Introduce the specimen; the concentration must be between 150 and 200. Operate the ultrasound manually during introduction.
Press the button “Real-time signals” again to close this window and release the automatic system to proceed with measurement.
Click the box “Start measurement”.

The median diameter of the particles is calculated directly by the equipment.

By “having a depth of penetration in the wood, in particular the ligneous parts, of at least 0.1 mm” is meant, within the meaning of the present invention, that at least one of the active ingredients is present in the wood, in particular the ligneous parts, at a distance of at least 0.1 mm from the outer surface of the wood, in particular of the ligneous parts of a fruit tree or grapevine with which the composition has been brought into contact.

The depth of penetration can be determined by evaluating the presence of said active ingredient in a specimen taken at a specified distance from the external part of the wood, in particular of the ligneous parts, by the following method:

A specimen of wood is taken from a plant and then cut according to the following procedure:

1. Brush the specimen to remove the surplus product from the surface.

2. Remove the bark (with a scalpel).

3. Cut (with a saw) “discs” with a width from 2 to 3 cm (variable number of discs depending on the geometry of the specimen).

4. Take (with a microtome) the first 1.5 mm of wood over the whole circumference of the discs=layer A (0 to 1.5 mm).

5. Take (with a microtome) the next 1.5 mm of wood over the whole circumference of the discs=layer B (1.5 to 3 mm). In the case of spurs, layer B goes from 1.5 mm to the pith.

6. Take (with a microtome) the next 2 mm of wood over the whole circumference of the discs in the case of cordons de Royat=layer C (3 to 5 mm).

For each of the batches and each of the layers, the active ingredients are extracted from the wood, in particular from the ligneous parts according to the following extraction protocol:
a. Extraction of the whole batch with ethyl acetate by the ASE 100 system (Accelerated Solvent Extraction, Dionex) under the following conditions:

Extraction conditions by ASE 100

| Parameters | Analytical conditions |
|---|---|
| Solvent | Ethyl acetate |
| Temperature | 90° C. |
| Pressure | 100 bar |
| Initial heating time | 5 minutes |
| Extraction time | 20 minutes |
| Rinse volume | 100% of the cell volume (34 ml) |
| Purge time (nitrogen U) | 90 seconds |

b. evaporate the extract to dryness in a rotary evaporator and take it up again in 2 ml of ethyl acetate,
c. add two internal standards to this extract in 2 ml of ethyl acetate (1,2,4,5-tetramethylbenzene and dieldrin, in the case of chlorothalonil and tebuconazole), for quantification of the active ingredient,
d. analyse by gas chromatography coupled to a mass spectrometer on Clarus® 500 GC-MS equipment from the company Perkin Elmer, in SIM (Single Ion Monitoring) mode with one ion for the quantification and two “qualifying” ions per compound.

In the present invention, the depth of penetration is defined by taking a cordon de Royat of grapevine more than one year old as the specimen.

The present invention therefore relates in particular to a fungicide composition in the form of a concentrated suspension of formula (I) comprising:
at least two active ingredients in the form of solid particles, the first active ingredient being selected from the penetrating and/or systemic antifungals and the second active ingredient being selected from the contact antifungals,
at least one bark penetrating agent,

the median diameter D₅₀ of the solid particles being from 0.1 to 1 μm, advantageously from 0.3 to 0.8 μm, in particular from 0.7 to 0.8 μm,

said composition having a depth of penetration of at least one of the active ingredients into the wood, in particular the ligneous parts, of at least 0.1 mm, as determined by the method consisting of:

1. Applying the phytosanitary composition under test by spraying, close to the point of runoff, during the dormant period in winter, on 15 completely dry vine plants (5 cordons per product) and not during a rainy period,

2. One week after application of the phytosanitary products, taking 15 treated specimens (1 piece from wood more than a year old per cordon for analysis),

3. Brushing the specimen to remove the surplus product on the surface,

4. Removing the bark (with a scalpel),

3. Cutting (with a saw) “discs” with a width from 2 to 3 cm (variable number of discs depending on the geometry of the specimen),

4. Taking (with a microtome) the first 1.5 mm of wood over the whole circumference of the discs=layer A (0 to 1.5 mm),

5. Taking (with a microtome) the next 1.5 mm of wood over the whole circumference of the discs=layer B (1.5 to 3 mm),

6. Taking (with a microtome) the next 2 mm of wood over the whole circumference of the discs in the case of cordons=layer C (3 to 5 mm),

7. Extracting the active ingredients from the ligneous parts according to the following extraction protocol:
a. Extract the whole batch with ethyl acetate by the ASE 100 system (Accelerated Solvent Extraction, Dionex) under the following conditions:

Extraction conditions by ASE 100

| Parameters | Analytical conditions |
|---|---|
| Solvent | Ethyl acetate |
| Temperature | 90° C. |
| Pressure | 100 bar |
| Initial heating time | 5 minutes |
| Extraction time | 20 minutes |
| Rinse volume | 100% of the cell volume (34 ml) |
| Purge time (nitrogen U) | 90 seconds |

b. evaporate the extract to dryness in a rotary evaporator and take it up again in 2 ml of ethyl acetate,
c. add two internal standards to this extract in 2 ml of ethyl acetate (1,2,4,5-tetramethylbenzene and dieldrin, in the case of chlorothalonil and tebuconazole), for quantification of the active ingredient,
d. analyse by gas chromatography coupled to a mass spectrometer on Clarus® 500 GC-MS equipment from the company Perkin Elmer, in SIM (Single Ion Monitoring) mode with one ion for quantification and two “qualifying” ions per compound.

To guarantee efficacy of the treatment, the active ingredients must be capable of penetrating into the ligneous parts to a sufficient depth to act on the fungus responsible for the disease. Thus, it has been demonstrated that the median diameter of the particles should be from 0.1 to 1 μm, advantageously from 0.3 to 0.8 μm, in particular from 0.7 to 0.8 μm, to allow penetration of the active ingredient into the wood, in particular the ligneous parts, of a perennial plant. In the formulations currently on the market, the median diameter of the particles of active ingredient is typically of the order of 1.5 μm. This larger diameter is explained by the absence of the need for such fine grinding because it is easier for the active ingredient to penetrate into the foliar parts, but especially because of the increased risk of burning of the leaves (phytotoxicity) with particles with a diameter of 1 μm or less.

The penetrating and/or systemic antifungal is selected from the group constituted by the acyalanines, benzimidazole thiophanates, N-phenylcarbamates, toluamides, pyridinylethylbenzamides, pyrazole-4-carboxamides, pyridine-carboxamides; methoxy-acrylates, methoxy-carbamates, oximinoacetates, oximinoacetamides, oxazolidinediones, dihydro-dioxazines, imidazolinones, cyano-imidazoles, sulphamoyl-triazoles, dinitrophenylcrotonates, triazolo-pyrimidylamines, aniline-pyrimidines, aryloxyquinolines, quinazolinones, phenylpyrroles, dicarboximides, carbamates, pyrimidines, imidazoles; triazoles, morpholines, piperidines, spirocetal-amines, hydroxanilides, amides of cinnamic acid, valinamide carbamates, amides of mandelic acid, cyanoacetamide-oximes, ethylphosphonates, phenylacetamides, benzophenones and benzoylpyridines.

These various classes of antifungals are in particular defined by the Fungicide Resistance Action Committee (FRAC).

Advantageously, the penetrating and/or systemic antifungal is selected from the group constituted by tetraconazole, tebuconazole, cyproconazole, cyprodinil, fenhexamid and fludioxonil.

More advantageously, the penetrating and/or systemic antifungal is a demethylation inhibitor (DMI), in particular selected from the group constituted by the triazoles. It is in particular tetraconazole, cyproconazole or tebuconazole.

The contact antifungal is advantageously selected from the group constituted by inorganic compounds, dithiocarbamates and derivatives thereof, phthalimides, chloronitriles and phthalonitriles, sulphamides, guanidines, triazines, quinones and anthraquinones, quinoxalines, maleimides and 2,6-dinitroanilines, advantageously from the copper salts, sulphur, mancozeb, maneb, metiram, propineb, thiram, zineb, ziram, captan, captafol, folpet, chlorothalonil, dichlofluanid, tolylfluanid, dithianon and fluazinam.

These various classes of antifungals are in particular defined by the Fungicide Resistance Action Committee (FRAC).

Advantageously, the contact antifungal is a broad-spectrum contact antifungal, in particular a chloronitrile, in particular chlorothalonil or a dinitroaniline, in particular fluazinam or metiram. Preferably, it is chlorothalonil.

In the compositions according to the present invention, the relative proportion of the penetrating and/or systemic antifungal and the contact antifungal can be modified depending on the disease of the wood, in particular of the ligneous parts to be treated. The ratio of the penetrating and/or systemic antifungal to the contact antifungal is from 75:25 to 25:75 by weight, in particular 40:60 to 60:40.

As the compositions according to the present invention are in the form of concentrated suspensions to be diluted in water at the time of use, the active ingredients represent a high proportion of the total composition. The proportion by weight of the penetrating and/or systemic antifungal relative to the total volume of the concentrated suspension represents from 5 to 45%, advantageously from 20 to 30%, in particular about 25% (w/v).

The ratio of the weight of the two active ingredients taken together to the total volume of the composition is 30:70, advantageously 40:60, in particular 50:50.

Advantageously, the proportion by weight of the penetrating and/or systemic antifungal relative to the total volume of the concentrated suspension therefore represents from 5 to 45%, advantageously from 20 to 30%, in particular about 25% (w/v) and the ratio of the weight of the two active ingredients taken together to the total volume of the composition is 30:70, advantageously 40:60, in particular 50:50.

Advantageously, the compositions according to the present invention contain the penetrating and/or systemic antifungal and the contact antifungal in equivalent quantities by weight, i.e. in a 50:50 ratio.

In the compositions according to the present invention, the bark penetrating agent is present in order to promote the diffusion of at least one active ingredient selected from the penetrating and/or systemic antifungal and the contact antifungal from the external surface of the wood, in particular of the ligneous parts to the interior of the wood, in particular of the ligneous parts. As the active ingredient is able to penetrate into the wood, in particular the ligneous parts, it is thus possible to act against the fungi responsible for the diseases of the wood, in particular of the ligneous parts at depth and prevent and/or treat the wood, in particular the ligneous parts, of the plant.

The proportion of the bark penetrating agent relative to the total weight of the composition is advantageously from 0.1 to 5%, in particular from 0.5 to 2%, preferably from 0.5 to 1%.

The bark penetrating agent can be a solvent possessing penetrating properties, advantageously selected from the group constituted by mineral oils, vegetable oils, petroleum derivatives, such as oil of turpentine or fuel oil, dimethylsulphoxide, N-methylpyrrolidone, xylene and methylene chloride or a surfactant possessing penetrating properties, advantageously selected from the group constituted by ethoxylated or propoxylated fatty alcohols, ethoxylated or propoxylated tallow fatty amines, sorbitan esters, advantageously sorbitan laurate, sorbitan stearates, sorbitan oleates and sorbitan palmitate, glycol esters, advantageously glycol stearate or glycol oleate, polyethoxylated heptamethyl trisiloxane, phosphate/alcohol mixtures, advantageously phosphate/ethoxylated or propoxylated fatty alcohols and phosphate/fluorinated alcohols, fluoro-surfactants, and dialkylsulphosuccinates, advantageously diethylcyclohexyl sodium sulphosuccinate or a solvent possessing penetrating properties selected from a mineral oil, a vegetable oil, petroleum derivatives such as oil of turpentine or fuel oil, dimethylsulphoxide, N-methylpyrrolidone, xylene and methylene chloride.

By “possessing penetrating properties” is meant, within the meaning of the present invention, that a compound allows diffusion of the active ingredient from the surface of the wood, in particular of the ligneous parts with which the composition has been brought into contact, to a depth of at least 0.1 mm in the wood, in particular the ligneous parts, advantageously of at least 1 mm, in particular of at least 2 mm.

As the ligneous parts are very similar structurally from one perennial plant to another, a given composition containing a bark penetrating agent, allowing penetration of the active ingredients into the ligneous parts of a given perennial plant, will be usable with other perennial plants. Thus, the compositions according to the present invention that are able to promote penetration of the active ingredients into the ligneous parts of the grapevine will be usable with other perennial plants such as fruit trees. It will of course be possible to modify the active ingredient depending on the disease to be treated. Advantageously, the bark penetrating agent is a surfactant possessing penetrating properties selected from the group constituted by the fluoro-surfactants, mixtures of phosphate/ethoxylated or propoxylated alcohol, phosphate/ethoxylated C₉ to C₁₁ alcohols and phosphate/ethoxylated C₁₀ to C₁₄ alcohols, and diethylcyclohexyl sodium sulphosuccinate.

The diameter of the particles is an important parameter for the penetration of the active ingredient into the wood, in particular the ligneous parts, of the perennial plant. When the median diameter D₅₀ of the particles of active ingredients is greater than 1 μm, the active ingredient does not penetrate in sufficient quantity into the wood, in particular the ligneous parts, of the perennial plant.

For health protection and regulatory reasons, the median diameter of the particles of active ingredients must not be less than 0.1 μm.

The median diameter D₅₀ of the solid particles in the concentrated suspensions according to the invention is from 0.1 to 1 μm, advantageously from 0.3 to 0.8 μm, in particular from 0.7 to 0.8 μm, as measured under the conditions described above.

In the compositions according to the present invention, 100% of the particles of active ingredients have a diameter of less than or equal to 5 μm, advantageously less than 4 μm.

Advantageously, at least 75%, advantageously at least 90%, of the solid particles have a diameter of less than 2 μm.

The compositions according to the present invention are formulated in such a way that the two active ingredients have a depth of penetration into the wood, in particular the ligneous parts, of at least 0.1 mm.

Advantageously, the depth of penetration of at least one of the active ingredients, advantageously of both active ingredients, is at least 1 mm, even more advantageously at least 2 mm.

The present invention also relates to compositions of formula (I) in which the penetrating and/or systemic antifungal is selected from the group constituted by tetraconazole, tebuconazole, cyprodinil, fenhexamid and fludioxonil and the contact antifungal is selected from the group constituted by chlorothalonil, fluazinam and metiram zinc.

The compositions according to the invention therefore comprise a combination of penetrating and/or systemic antifungal and contact antifungal selected from the group constituted by tetraconazole and chlorothalonil, tetraconazole and fluazinam, tetraconazole and metiram zinc, tebuconazole and chlorothalonil, tebuconazole and fluazinam, tebuconazole and metiram zinc, cyprodinil and chlorothalonil, cyprodinil and fluazinam, cyprodinil and metiram, fenhexamid and chlorothalonil, fenhexamid and fluazinam, fenhexamid and metiram zinc, fludioxonil and chlorothalonil, fludioxonil and fluazinam, fludioxonil and metiram zinc.

Preferably, the combination of penetrating and/or systemic antifungal and contact antifungal is selected from the group constituted by tetraconazole and chlorothalonil, cyproconazole and chlorothalonil, tetraconazole and metiram zinc, tebuconazole and chlorothalonil and tebuconazole and metiram zinc.

In an advantageous embodiment according to the present invention, the composition comprises a combination of penetrating and/or systemic antifungal/contact antifungal/bark penetrating agent selected from the group constituted by tetraconazole and chlorothalonil and fluoro-surfactants; tetraconazole and fluazinam and fluoro-surfactants; tetraconazole and metiram zinc and fluoro-surfactants; tebuconazole and chlorothalonil and fluoro-surfactants; tebuconazole and fluazinam and fluoro-surfactants; tebuconazole and metiram zinc and fluoro-surfactants; cyprodinil and chlorothalonil and fluoro-surfactants; cyprodinil and fluazinam and fluoro-surfactants; cyprodinil and metiram zinc and fluoro-surfactants; fenhexamid and chlorothalonil and fluoro-surfactants; fenhexamid and fluazinam and fluoro-surfactants; fenhexamid and metiram zinc and fluoro-surfactants; fludioxonil and chlorothalonil and fluoro-surfactants; fludioxonil and fluazinam and fluoro-surfactants; fludioxonil and metiram zinc and fluoro-surfactants; tetraconazole and chlorothalonil and mixture of phosphate and ethoxylated or propoxylated alcohols; tetraconazole and fluazinam and mixture of phosphate and ethoxylated or propoxylated alcohols; tetraconazole and metiram zinc and mixture of phosphate and ethoxylated or propoxylated alcohols; tebuconazole and chlorothalonil and mixture of phosphate and ethoxylated or propoxylated alcohols; tebuconazole and fluazinam and mixture of phosphate and ethoxylated or propoxylated alcohols; tebuconazole and metiram zinc and mixture of phosphate and ethoxylated or propoxylated alcohols; cyprodinil and chlorothalonil and mixture of phosphate and ethoxylated or propoxylated alcohols; cyprodinil and fluazinam and mixture of phosphate and ethoxylated or propoxylated alcohols; cyprodinil and metiram zinc and mixture of phosphate and ethoxylated or propoxylated alcohols; fenhexamid and chlorothalonil and mixture of phosphate and ethoxylated or propoxylated alcohols; fenhexamid and fluazinam and mixture of phosphate and ethoxylated or propoxylated alcohols; fenhexamid and metiram zinc and mixture of phosphate and ethoxylated or propoxylated alcohols; fludioxonil and chlorothalonil and mixture of phosphate and ethoxylated or propoxylated alcohols; fludioxonil and fluazinam and mixture of phosphate and ethoxylated or propoxylated alcohols; fludioxonil and metiram zinc and mixture of phosphate and ethoxylated or propoxylated alcohols; tetraconazole and chlorothalonil and mixture of phosphate/C₉ to C₁₁ alcohols; tetraconazole and fluazinam and mixture of phosphate/C₉ to C₁₁ alcohols; tetraconazole and metiram zinc and mixture of phosphate/C₉ to C₁₁ alcohols; tebuconazole and chlorothalonil and mixture of phosphate/C₉ to C₁₁ alcohols; tebuconazole and fluazinam and mixture of phosphate/C₉ to C₁₁ alcohols; tebuconazole and metiram zinc and mixture of phosphate/C₉ to C₁₁ alcohols; cyprodinil and chlorothalonil and mixture of phosphate/C₉ to C₁₁ alcohols; cyprodinil and fluazinam and mixture of phosphate/C₉ to C₁₁ alcohols; cyprodinil and metiram zinc and mixture of phosphate/C₉ to C₁₁ alcohols; fenhexamid and chlorothalonil and mixture of phosphate/C₉ to C₁₁ alcohols; fenhexamid and fluazinam and mixture of phosphate/C₉ to C₁₁ alcohols; fenhexamid and metiram zinc and mixture of phosphate/C₉ to C₁₁ alcohols; fludioxonil and chlorothalonil and mixture of phosphate/C₉ to C₁₁ alcohols; fludioxonil and fluazinam and mixture of phosphate/C₉ to C₁₁ alcohols; fludioxonil and metiram zinc and mixture of phosphate/C₉ to C₁₁ alcohols; tetraconazole and chlorothalonil and mixture of phosphate/ethoxylated C₁₀ to C₁₄ alcohols; tetraconazole and fluazinam and mixture of phosphate/ethoxylated C₁₀ to C₁₄ alcohols; tetraconazole and metiram zinc and mixture of phosphate/ethoxylated C₁₀ to C₁₄ alcohols; tebuconazole and chlorothalonil and mixture of phosphate/ethoxylated C₁₀ to C₁₄ alcohols; tebuconazole and fluazinam and mixture of phosphate/ethoxylated C₁₀ to C₁₄ alcohols; tebuconazole and metiram zinc and mixture of phosphate/ethoxylated C₁₀ to C₁₄ alcohols; cyprodinil and chlorothalonil and mixture of phosphate/ethoxylated C₁₀ to C₁₄ alcohols; cyprodinil and fluazinam and mixture of phosphate/ethoxylated C₁₀ to C₁₄ alcohols; cyprodinil and metiram zinc and mixture of phosphate/ethoxylated C₁₀ to C₁₄ alcohols; fenhexamid and chlorothalonil and mixture of phosphate/ethoxylated C₁₀ to C₁₄ alcohols; fenhexamid and fluazinam and mixture of phosphate/ethoxylated C₁₀ to C₁₄ alcohols; fenhexamid and metiram zinc and mixture of phosphate/ethoxylated C₁₀ to C₁₄ alcohols; fludioxonil and chlorothalonil and mixture of phosphate/ethoxylated C₁₀ to C₁₄ alcohols; fludioxonil and fluazinam and mixture of phosphate/ethoxylated C₁₀ to C₁₄ alcohols; fludioxonil and metiram zinc and mixture of phosphate/ethoxylated C₁₀ to C₁₄ alcohols; tetraconazole and chlorothalonil and diethylcyclohexyl sodium sulphosuccinate; tetraconazole and fluazinam and diethylcyclohexyl sodium sulphosuccinate; tetraconazole and metiram zinc and diethylcyclohexyl sodium sulphosuccinate; tebuconazole and chlorothalonil and diethylcyclohexyl sodium sulphosuccinate; tebuconazole and fluazinam and diethylcyclohexyl sodium sulphosuccinate; tebuconazole and metiram zinc and diethylcyclohexyl sodium sulphosuccinate; cyprodinil and chlorothalonil and diethylcyclohexyl sodium sulphosuccinate; cyprodinil and fluazinam and diethylcyclohexyl sodium sulphosuccinate; cyprodinil and metiram zinc and diethylcyclohexyl sodium sulphosuccinate; fenhexamid and chlorothalonil and diethylcyclohexyl sodium sulphosuccinate; fenhexamid and fluazinam and diethylcyclohexyl sodium sulphosuccinate; fenhexamid and metiram zinc and diethylcyclohexyl sodium sulphosuccinate; fludioxonil and chlorothalonil and diethylcyclohexyl sodium sulphosuccinate; fludioxonil and fluazinam and diethylcyclohexyl sodium sulphosuccinate; and fludioxonil and metiram zinc and diethylcyclohexyl sodium sulphosuccinate.

Advantageously, the composition comprises a combination of penetrating and/or systemic antifungal/contact antifungal/bark penetrating agent selected from the group constituted by tetraconazole and chlorothalonil and fluoro-surfactants; tebuconazole and chlorothalonil and fluoro-surfactants; cyproconazole and chlorothalonil and fluoro-surfactants; tetraconazole and metiram zinc and fluoro-surfactants; tebuconazole and metiram zinc and fluoro-surfactants; tetraconazole and chlorothalonil and mixture of phosphate and ethoxylated or propoxylated alcohols; tebuconazole and chlorothalonil and mixture of phosphate and ethoxylated or propoxylated alcohols; cyproconazole and chlorothalonil and mixture of phosphate and ethoxylated or propoxylated alcohols; tetraconazole and metiram zinc and mixture of phosphate and ethoxylated or propoxylated alcohols; tebuconazole and metiram zinc and mixture of phosphate and ethoxylated or propoxylated alcohols; tetraconazole and chlorothalonil and mixture of phosphate/C₉ to C₁₁ alcohols; tebuconazole and chlorothalonil and mixture of phosphate/C₉ to C₁₁ alcohols; cyproconazole and chlorothalonil and mixture of phosphate/C₉ to C₁₁ alcohols; tetraconazole and metiram zinc and mixture of phosphate/C₉ to C₁₁ alcohols; tebuconazole and metiram zinc and mixture of phosphate/C₉ to C₁₁ alcohols; tetraconazole and chlorothalonil and mixture of phosphate/ethoxylated C₁₀ to C₁₄ alcohols; tebuconazole and chlorothalonil and mixture of phosphate/ethoxylated C₁₀ to C₁₄ alcohols; cyproconazole and chlorothalonil and mixture of phosphate/ethoxylated C₁₀ to C₁₄ alcohols; tetraconazole and metiram zinc and mixture of phosphate/ethoxylated C₁₀ to C₁₄ alcohols; tebuconazole and metiram zinc and mixture of phosphate/ethoxylated C₁₀ to C₁₄ alcohols; tetraconazole and chlorothalonil and diethylcyclohexyl sodium sulphosuccinate; tebuconazole and chlorothalonil and diethylcyclohexyl sodium sulphosuccinate; cyproconazole and chlorothalonil and diethylcyclohexyl sodium sulphosuccinate; tetraconazole and metiram zinc and diethylcyclohexyl sodium sulphosuccinate; tebuconazole and metiram zinc and diethylcyclohexyl sodium sulphosuccinate.

The compositions according to the present invention contain, as well as the active ingredients and the bark penetrating agent, at least one component selected from dispersants, antifoaming agents, thickeners, inert organic solvents and preservatives. Advantageously, the compositions according to the present invention contain all of these components.

These additional components are used conventionally for preparing concentrated suspensions for phytopharmaceutical use.

The compositions according to the present invention can comprise a dispersant, advantageously present in the composition at a rate of 0.1 to 10% by weight, more advantageously from 2 to 8% by weight, in particular approximately 5% by weight relative to the total weight of the composition.

The dispersant is advantageously selected from the group constituted by the phosphate/ethoxylated alkylphenol mixtures, lignosulphonates, advantageously sodium lignosulphonate, and a mixture of these two dispersants.

The compositions according to the present invention can comprise an antifoaming agent, advantageously present in the composition at a rate of 0.01 to 1%, more advantageously 0.05 to 0.5%, in particular from 0.1 to 0.2%.

The antifoaming agent is advantageously selected from the siloxane derivatives, such as dimethoxypolysiloxane.

The compositions according to the present invention can comprise a thickener, advantageously present in the composition at a rate of 0.01 to 1% by weight, advantageously 0.5 to 1.5% by weight, in particular from 0.7 to 1% by weight relative to the total weight of the composition.

The thickener is advantageously selected from the group constituted by xanthan gum, guar gum, carob gum, carrageenans, gum arabic, tara gum, agar-agar, gellan gum and a mixture of at least two of these gums, a clay, advantageously attapulgite or a mixture of these thickeners.

The compositions according to the present invention can comprise a preservative, advantageously present in the composition at a rate of 0.01 to 1%, advantageously from 0.05 to 0.2%, in particular approximately 0.1% by weight relative to the total weight of the composition.

The preservative is advantageously selected from the group of the isothiazolinones possessing preserving properties, such as benzisothiazolinone.

The compositions according to the present invention can comprise an inert organic solvent, advantageously present in the composition at a rate of 0.1 to 10% by weight, advantageously from 2 to 8% by weight, in particular from 3 to 6% by weight relative to the total weight of the composition.

The inert organic solvent is advantageously selected from the group constituted by the glycols, such as monoethylene glycol and monopropylene glycol.

The present invention also relates to a composition of formula (II) comprising:
from 15 to 45%, advantageously from 20 to 30%, in particular approximately 25%, of the penetrating and/or systemic antifungal, relative to the total weight of the composition,
from 15 to 45%, advantageously from 20 to 30%, in particular approximately 25%, of the contact antifungal relative to the total weight of the composition,
from 0.1 to 5%, advantageously from 0.5 to 2%, in particular from 0.5 to 1%, of the bark penetrating agent relative to the total weight of the composition,

in which the systemic and/or penetrating antifungal, the contact antifungal and the bark penetrating agent are as defined for the compositions of formula (I).

Advantageously, the composition of formula (II) comprises a penetrating and/or systemic antifungal selected from the group constituted by the triazoles, advantageously tetraconazole, cyproconazole or tebuconazole, a contact antifungal selected from the group constituted by chlorothalonil, fluazinam and metiram zinc and a bark penetrating agent selected from the group constituted by the fluoro-surfactants, mixtures of phosphate/ethoxylated or propoxylated alcohol, phosphate/ethoxylated C₉ to C₁₁ alcohols and phosphate/ethoxylated C₁₀ to C₁₄ alcohols, and diethylcyclohexyl sodium sulphosuccinate.

In particular compositions of formula (IIa), the active ingredients are tetraconazole and chlorothalonil, cyproconazole and chlorothalonil, tetraconazole and metiram zinc, tebuconazole and chlorothalonil or tebuconazole and metiram zinc and the bark penetrating agent is a fluoro-surfactant, a mixture of phosphate/ethoxylated C₉ to C₁₁ alcohols or phosphate/ethoxylated C₁₀ to C₁₄ alcohols, advantageously a mixture of phosphate/ethoxylated C₉ to C₁₁ alcohols or phosphate/ethoxylated C₁₀ to C₁₄ alcohols, or a mixture of these two mixtures.

In a particular composition of formula (IIa1), the active ingredients are tebuconazole and chlorothalonil and the bark penetrating agent is a mixture of phosphate/ethoxylated C₉ to C₁₁ alcohols or phosphate/ethoxylated C₁₀ to C₁₄ alcohols, or a mixture of these two mixtures. Advantageously, the penetrating and/or systemic antifungal is present in the composition at a rate of 20 to 30%, in particular approximately 25%, relative to the total weight of the composition, the contact antifungal is present at a rate of 20 to 30%, in particular approximately 25%, relative to the total weight of the composition, and the bark penetrating agent is present at a rate of 0.5 to 2%, in particular from 0.5 to 1%, relative to the total weight of the composition.

Advantageously, the compositions according to the present invention in which the active ingredients are tebuconazole and chlorothalonil allow penetration of the active ingredients to a depth of at least 10%, advantageously of at least 20%, in particular of at least 50% relative to the thickness of the wood, in particular of the ligneous parts measured from the external surface to the heart, the bark of the wood, in particular of the ligneous parts not being included in the thickness of the wood, in particular of the ligneous parts.

The present invention also relates to a composition as defined above in which the active ingredients are tebuconazole and chlorothalonil, characterized in that the quantity of active ingredients that have penetrated into the wood, in particular the ligneous parts, more than one year old, as measured by the method for determining the depth of penetration described above, is at least 60 mg of active ingredients, advantageously at least 75 mg, per kg of wood at a depth from 0 to 1.5 mm.

The present invention also relates to a composition as defined above in which the active ingredients are tebuconazole and chlorothalonil, characterized in that the quantity of active ingredients that have penetrated into the wood, in particular the ligneous parts, more than one year old, as measured by the method for determining the depth of penetration described above, is at least 20 mg of active ingredients, advantageously at least 25 mg, per kg of wood at a depth from 1.5 to 3 mm in old wood.

The present invention also relates to a composition as defined above in which the active ingredients are tebuconazole and chlorothalonil, characterized in that the quantity of active ingredients that have penetrated into the wood, in particular the ligneous parts, more than one year old, as measured by the method for determining the depth of penetration described above, is at least 2 mg of active ingredients, advantageously at least 4 mg, preferably at least 5 mg, per kg of wood at a depth greater than 3 mm.

The present invention also relates to a composition as defined above in which the active ingredients are tebuconazole and chlorothalonil, characterized in that the quantity of active ingredients that have penetrated into the wood, in particular the ligneous parts, of the current year, as measured by the method for determining the depth of penetration described above, is at least 2 mg of active ingredients, in particular 2.8 mg, per kg of wood at a depth from 0 to 1.5 mm in the wood, in particular the ligneous parts, of the current year.

The present invention also relates to a composition as defined above in which the active ingredients are tebuconazole and chlorothalonil, characterized in that the quantity of active ingredients that have penetrated into the wood, in particular the ligneous parts, of the current year, as measured by the method for determining the depth of penetration described above, is at least 0.7 mg of active ingredients, in particular 0.75 mg per kg of wood at a depth of 1.5 mm at the pith.

The present invention also relates to a composition of formula (III) comprising, or consisting of, by weight relative to the total weight of the composition:
20 to 30%, advantageously approximately 25%, of at least one penetrating and/or systemic antifungal,
20 to 30%, advantageously approximately 25%, of at least one contact antifungal,
0.5 to 2%, advantageously from 0.5 to 1% of at least one bark penetrating agent,
2 to 8%, advantageously approximately 5% of at least one dispersant,
0.05 to 0.5%, advantageously 0.1 to 0.2% of at least one antifoaming agent,
0.05 to 0.2%, advantageously approximately 0.1% of at least one preservative,
0.5 to 1.5%, advantageously 0.7 to 1% of at least one thickener,
2 to 8%, advantageously 3 to 6% of at least one organic solvent, and
21.3 to 44.6% of water,

in which the systemic and/or penetrating antifungal, the contact antifungal, the bark penetrating agent, the dispersant, the antifoaming agent, the preservative, the thickener and the organic solvent are as defined for the compositions of formula (I).

The present invention also relates to a particular composition of formula (IIIa) comprising or consisting of, by weight relative to the total weight of the composition:
20 to 30%, advantageously approximately 25% of tetraconazole, cyproconazole or tebuconazole, preferably tebuconazole.
20 to 30%, advantageously approximately 25%, of chlorothalonil, fluazinam or metiram zinc, preferably chlorothalonil,
0.5 to 2%, advantageously from 0.5 to 1% of a phosphate/fatty alcohol mixture,
2 to 8%, advantageously approximately 5% of a mixture of t phosphate/ethoxylated alkylphenol and sodium lignosulphate,
0.05 to 0.5%, advantageously 0.1 to 0.2% of dimethoxypolysiloxane,
0.05 to 0.2%, advantageously approximately 0.1% of isobenzothiazolidinone,
0.5 to 1.5%, advantageously 0.7 to 1% of a thickener, advantageously xanthan gum and attapulgite,
2 to 8%, advantageously 3 to 6% of monopropylene glycol, and
21.3 to 44.6% of water.

In a particularly advantageous embodiment according to the present invention, the composition is a concentrated suspension of formula (IV) comprising a systemic and/or penetrating antifungal, preferably tebuconazole and a contact antifungal, preferably chlorothalonil, in which the active ingredients have a synergistic effect, i.e. the activity of the composition comprising the two active ingredients is greater than the theoretical activity calculated from that of the compositions comprising just one of the same active ingredients. The method for determining the existence of a synergistic effect is described in Example 4 of the present application and consists of comparing the IC 90 (or 50) and the theoretical IC 90 (or 50) calculated from the results obtained for each of the active ingredients alone and for the combination using the following equation:

$$\begin{matrix}IC th \\ =\end{matrix} \frac{a + b}{\frac{a}{IC A} + \frac{b}{IC B}}$$

The type and the level of interaction F are then calculated by dividing the theoretical IC value by the experimental IC observed for the combination of antifungals (F=theoretical IC/experimental IC).

The interactions are defined thus:
Additivity: F=1,
Synergy: F>1,
Antagonism: F<1.

Preferably, said active ingredients displaying a synergistic effect are tebuconazole and chlorothalonil and the bark penetrating agent is a mixture of phosphate/ethoxylated C₉ to C₁₁ alcohols or phosphate/ethoxylated C₁₀ to C₁₄ alcohols, or a mixture of these two mixtures, the penetrating and/or systemic antifungal being present in the composition at a rate of 20 to 30%, in particular approximately 25%, relative to the total weight of the composition, the contact antifungal being present at a rate of 20 to 30%, in particular approximately 25%, relative to the total weight of the composition, and the bark penetrating agent being present at a rate of 0.5 to 2%, in particular from 0.5 to 1%, relative to the total weight of the composition.

Even more advantageously, the composition is a composition of formula (IVa), comprising or consisting of, by weight relative to the total weight of the composition:
20 to 30%, advantageously approximately 25% of tebuconazole,
20 to 30%, advantageously approximately 25%, of chlorothalonil,
0.5 to 2%, advantageously from 0.5 to 1% of a mixture of phosphate/fatty alcohol, preferably a mixture of phosphate/ethoxylated C₉ to C₁₁ alcohols or phosphate/ethoxylated C₁₀ to C₁₄ alcohols, or a mixture of these two mixtures
2 to 8%, advantageously approximately 5% of a mixture of the phosphate/ethoxylated alkylphenol mixture and sodium lignosulphate,
0.05 to 0.5%, advantageously 0.1 to 0.2% of dimethoxypolysiloxane,
0.05 to 0.2%, advantageously approximately 0.1% of a preservative, advantageously a thiazolidinone, preferably isobenzothiazolidinone,
0.5 to 1.5%, advantageously 0.7 to 1% of a thickener, advantageously xanthan gum and attapulgite,
2 to 8%, advantageously 3 to 6% of monopropylene glycol, and
21.3 to 44.6% of water.

Preferably, the compositions of formula (I), (II), (III), (IV), (IIa), (IIa1), (IIIa) and (IVa) according to the present invention are devoid of a third active ingredient, in particular a triazolyl derivative, in particular a triazolyl derivative selected from the group constituted by the compounds of formula:

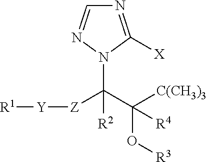

in which:

X═H, Y═O, Z═(CH₂)₄, R¹=2-fluorophenyl and R², R³ and R⁴═H;

X═SH, Y═O, Z═(CH₂)₄, R¹=2-fluorophenyl and R², R³ and R⁴═H;

X═H, Y=a single bond to R′, Z═CH₂—CH(CH₃)—CH₂—, R¹=2,4-dichlorophenyl and

R², R³ and R⁴═H; and

X═SH, Y=a single bond to R′, Z═CH₂—CH(CH₃)—CH₂—, R¹=2,4-dichlorophenyl and R², R³ and R⁴═H.

The compositions according to the present invention in the form of a concentrated suspension are used in the form of a suspension diluted in water. The present invention therefore also relates to a dilute suspension comprising a composition in the form of a concentrated suspension of formula (I), (II), (III), (IV), (IIa), (IIa1), (IIIa) and (IVa).

By “dilute suspension” is meant, within the meaning of the present invention, a composition in which the water-insoluble solid active ingredients are held in suspension and in which water represents the major part by volume of the total volume of the suspension.

Advantageously, the dilute suspension comprises from 50 to 99% of water, in particular from 90 to 99%, preferably approximately 96%, relative to the total volume of the dilute suspension.

The concentrated suspension or the dilute suspension as defined above possesses antifungal activity against the fungi responsible for the diseases of the wood, in particular of the ligneous parts of a plant, in particular of fruit trees and grapevines, and allows penetration of the active ingredients into the wood, in particular the ligneous parts of the plant.

The present invention therefore also relates to the use of a fungicide composition in the form of a concentrated suspension of formula (I), (II), (III), (IV), (IIa), (IIa1), (IIIa) and (IVa) or of a dilute suspension comprising a concentrated suspension of formula (I), (II), (III), (IV), (IIa), (IIa1), (IIIa) and (IVa) as described above for preventing and/or treating at least one disease of the wood, in particular of the ligneous parts of a plant, advantageously of the wood, in particular of the ligneous parts of fruit trees or grapevines.

The present invention relates more particularly to the use of a fungicide composition in the form of a concentrated suspension of formula (I), (II), (III), (IV), (IIa), (IIa1), (IIIa) and (IVa) or of a dilute suspension comprising a concentrated suspension of formula (I), (II), (III), (IV), (IIa), (IIa1), (IIIa) and (IVa) as described above for preventing and/or treating at least one disease of the wood, in particular of the ligneous parts of the grapevine belonging to the group constituted by Eutypiosis, Esca, black dead arm (BDA) and Petri disease.

Advantageously, the present invention relates more particularly to the use of a fungicide composition in the form of a concentrated suspension of formula (I), (II), (III), (IV), (IIa), (IIa1), (IIIa) and (IVa) or of a dilute suspension comprising a concentrated suspension of formula (I), (II), (III), (IV), (IIa), (IIa1), (IIIa) and (IVa) as described above for preventing and/or treating at least one disease of the wood, in particular of the ligneous parts of fruit trees belonging to the group constituted by crown gall, European canker and fire blight.

The present invention also relates more particularly to the use of a fungicide composition in the form of a concentrated suspension of formula (I), (II), (III), (IV), (IIa), (IIa1), (IIIa) and (IVa) or of a dilute suspension comprising a concentrated suspension of formula (I), (II), (III), (IV), (IIa), (IIa1), (IIIa) and (IVa) as described above for preventing and/or treating at least one disease of the wood, in particular of the ligneous parts of fruit trees caused by Erwinia amylovora, Nectria galligena or Phytophthora cactorum.

The compositions of formula (I), (II), (III), (IV), (IIa), (IIa1), (IIIa) and (IVa) according to the present invention are active against the fungi associated with and/or responsible for diseases of the wood, in particular of the ligneous parts of trees, in particular of the wood, in particular of the ligneous parts of fruit trees and grapevines.

The present invention therefore also relates to the use of a fungicide composition in the form of a concentrated suspension of formula (I), (II), (III), (IV), (IIa), (IIa1), (IIIa) and (IVa) or of a dilute suspension comprising a concentrated suspension of formula (I), (II), (III), (IV), (IIa), (IIa1), (IIIa) and (IVa) as described above for preventing and/or treating at least one disease of the wood, in particular of the ligneous parts of a plant, advantageously of the wood, in particular of the ligneous parts of fruit trees or grapevines, associated with or caused by Eutypa lata, Phaeoacremonium aleophilum, Fomitiporia mediterranea, Botryospheria spp., Phaeomoniella chlamydospora, Phytophthora spp., Neonectria galligena and Erwinia amylovora.

Advantageously, the plant is a lignified branch (after lignification), advantageously more than one year old.

The present invention relates to the use of a fungicide composition in the form of a concentrated suspension of formula (I), (II), (III), (IV), (IIa), (IIa1), (IIIa) and (IVa) or of a dilute suspension comprising a concentrated suspension of formula (I), (II), (III), (IV), (IIa), (IIa1), (IIIa) and (IVa) as described above on a plant in the dormant stage. Preferably, the composition is used on the wood, in particular the ligneous parts, of a plant once a year, advantageously on a plant at a stage between maturation of the previous year and bud burst of the current year, in particular between leaf fall of the previous year and bud burst of the current year, in particular between maturity of the wood and the end of bud burst (50% of the buds at stage BBCH 05), in particular between leaf fall of the previous year and the end of bud burst (50% of the buds at stage BBCH 05).

The fungicide composition that is in the form of a concentrated suspension of formula (I), (II), (III), (IV), (IIa), (IIa1), (IIIa) and (IVa) or the dilute suspension comprising a concentrated suspension of formula (I), (II), (III), (IV), (IIa), (IIa1), (IIIa) and (IVa) is used for preventing and/or treating at least one disease of the wood, in particular of the ligneous parts as described above by methods commonly used in arboriculture, in particular by spraying on the wood, in particular the ligneous parts, by dipping the wood, in particular the ligneous parts, by painting pruning wounds or by ground spraying.

Advantageously, the present invention therefore relates to the use of a fungicide composition in the form of a concentrated suspension of formula (I), (II), (III), (IV), (IIa), (IIa1), (IIIa) and (IVa) or of a dilute suspension comprising a concentrated suspension of formula (I), (II), (III), (IV), (IIa), (IIa1), (IIIa) and (IVa) in which the systemic and/or penetrating antifungal is tebuconazole and the contact antifungal is chlorothalonil for preventing and/or treating a disease of the wood, in particular of the ligneous parts of the grapevine associated with and/or caused by Diplodia seriata, Neofusicoccum parvum and/or Fomitiporia mediterranea, in particular black dead arm and/or Esca in the wood, in particular the ligneous parts, of the grapevine. Advantageously, the bark penetrating agent is a fluoro-surfactant, a mixture of phosphate/ethoxylated C₉ to C₁₁ alcohols or phosphate/ethoxylated C₁₀ to C₁₄ alcohols, preferably a mixture of phosphate/ethoxylated C₉ to C₁₁ alcohols or phosphate/ethoxylated C₁₀ to C₁₄ alcohols, or a mixture of these two mixtures.

The present invention further relates to a method for preventing and/or treating diseases of the wood, in particular of the ligneous parts comprising a step of bringing the wood, in particular the ligneous parts, of a plant into contact with a fungicide composition in the form of a concentrated suspension of formula (I), (II), (III), (IV), (IIa), (IIa1), (IIIa) and (IVa) or of a dilute suspension comprising a concentrated suspension of formula (I), (II), (III), (IV), (IIa), (IIa1), (IIIa) and (IVa), the plant preferably being the grapevine or a fruit tree.

The present invention relates more particularly to a method for preventing and/or treating diseases of the wood, in particular of the ligneous parts of the grapevine belonging to the group constituted by Eutypiosis, Esca, black dead arm (BDA) and Petri disease or of a disease of fruit trees belonging to the group constituted by crown gall, European canker and fire blight, comprising a step of bringing the wood, in particular the ligneous parts of a plant, in particular the grapevine or a fruit tree, into contact with a fungicide composition in the form of a concentrated suspension of formula (I), (II), (III), (IV), (IIa), (IIa1), (IIIa) and (IVa) or of a dilute suspension comprising a concentrated suspension of formula (I), (II), (III), (IV), (IIa), (IIa1), (IIIa) and (IVa).

The present invention relates more particularly to a method for preventing and/or treating diseases of the wood, in particular of the ligneous parts of grapevines and fruit trees caused by Phaeomoniella chlamydospora, Phaeoacremonium aleophilum, Fomitiporia mediterranea, Eutypa lata, Botryospheria spp., Phytophthora spp., Neonectria galligena and Erwinia amylovora, comprising a step of bringing the wood, in particular the ligneous parts of a plant, in particular the grapevine or a fruit tree, into contact with a fungicide composition in the form of a concentrated suspension of formula (I), (II), (III), (IV), (IIa), (IIa1), (IIIa) and (IVa) or of a dilute suspension comprising a concentrated suspension of formula (I), (II), (III), (IV), (IIa), (IIa1), (IIIa) and (IVa).

Advantageously, the method is carried out with a dilute suspension comprising a concentrated suspension of formula (I), (II), (III), (IV), (IIa), (IIa1), (IIIa) and (IVa), the proportion of water in the dilute solution being from 50 to 99%, in particular from 90 to 99%, preferably approximately 96%, relative to the total volume of the dilute suspension.

The concentration of concentrated suspension of formula (I), (II), (III), (IV), (IIa), (IIa1), (IIIa) and (IVa) in the dilute suspension depends on the state of progression of the disease of the wood, in particular of the ligneous parts, the age of the wood, in particular of the ligneous parts and the method used for bringing the wood, in particular the ligneous parts, into contact with the composition of formula (I), (II), (III), (IV), (IIa), (IIa1), (IIIa) and (IVa).

Advantageously, the plant is a lignified branch (after lignification), advantageously more than one year old.

Advantageously, the present invention relates to a method in which the wood, in particular the ligneous parts, of the plant is brought into contact with a fungicide composition in the form of a concentrated suspension of formula (I), (II), (III), (IV), (IIa), (IIa1), (IIIa) and (IVa) or a dilute suspension comprising a concentrated suspension of formula (I), (II), (III), (IV), (IIa), (IIa1), (IIIa) and (IVa), once a year, said plant being in the dormant stage.

Preferably, the plant is at a stage between maturation of the previous year and bud burst of the current year, in particular between leaf fall of the previous year and bud burst of the current year, in particular between maturity of the wood and the end of bud burst (50% of the buds at stage BBCH 05), in particular between leaf fall of the previous year and the end of bud burst (50% of the buds at stage BBCH 05). Bringing the plant into contact with the composition at this stage between leaf fall of the previous year and bud burst of the current year in particular makes it possible to avoid bringing the composition into contact with the foliar parts of the plant for which it would be phytotoxic at a development stage of the plant. The step of contacting the wood, in particular the ligneous parts of plants, advantageously the grapevine or a fruit tree, can be implemented by various known methods, advantageously by spraying the composition on the wood, in particular the ligneous parts, by dipping the wood, in particular the ligneous parts in the composition, by painting the pruning wounds or by ground spraying.

The plant is brought into contact with a composition at a rate from 1,000 g to 10,000 g of each of the active ingredients, advantageously from 2,000 g to 8,000 g per hectare of wood to be treated.

The present invention further relates to a kit making it possible to prepare a concentrated suspension as defined above.

In an embodiment, said kit can comprise:
the at least two active ingredients in the form of solid particles in a first container,
the at least one bark penetrating agent in a second container.

In another embodiment, said kit can comprise:
the first active ingredient selected from penetrating and/or systemic antifungals in the form of solid particles in a first container,
the second active ingredient selected from contact antifungals in the form of solid particles in a second container,
the at least one bark penetrating agent in a third container.

The penetration of an active ingredient into the wood is improved by using a bark penetrating agent and by reducing the median diameter of the particles.

The present invention therefore also relates to the use of at least one active ingredient in the form of solid particles in suspension with median diameter D₅₀ from 0.1 to 1 μm, advantageously from 0.3 to 0.8 μm, in particular from 0.7 to 0.8 μm and of a bark penetrating agent selected from the group constituted by the fluoro-surfactants, mixtures of phosphate/ethoxylated or propoxylated alcohol, phosphate/ethoxylated C₉ to C₁₁ alcohols and phosphate/ethoxylated C₁₀ to C₁₄ alcohols, and diethylcyclohexyl sodium sulphosuccinate for improving the penetration of the at least one active ingredient into the wood, in particular the ligneous parts of a perennial plant, in particular a fruit tree or the grapevine.

The present invention thus relates in particular to the use of at least two active ingredients in the form of solid particles in suspension with median diameter D₅₀ from 0.1 to 1 μm, advantageously from 0.3 to 0.8 μm, in particular from 0.7 to 0.8 μm, the first active ingredient being selected from the penetrating and/or systemic antifungals and the second active ingredient being selected from the contact antifungals and a bark penetrating agent selected from the group constituted by the fluoro-surfactants, mixtures of phosphate/ethoxylated or propoxylated alcohol, phosphate/ethoxylated C₉ to C₁₁ alcohols and phosphate/ethoxylated C₁₀ to C₁₄ alcohols, and diethylcyclohexyl sodium sulphosuccinate for improving the penetration of at least one of said active ingredients into the wood, in particular the ligneous parts of a perennial plant, in particular a fruit tree or the grapevine.

In a particular embodiment, the present invention relates to the use of at least two active ingredients in the form of solid particles in suspension with median diameter D₅₀ from 0.1 to 1 μm, advantageously from 0.3 to 0.8 μm, in particular from 0.7 to 0.8 μm, the first active ingredient being selected from tetraconazole, tebuconazole, cyproconazole, cyprodinil, fenhexamid and fludioxonil and the second active ingredient being selected from chlorothalonil, fluazinam and metiram zinc, preferably tebuconazole and chlorothalonil and a bark penetrating agent selected from the group constituted by the fluoro-surfactants, mixtures of phosphate/ethoxylated or propoxylated alcohol, phosphate/ethoxylated C₉ to C₁₁ alcohols and phosphate/ethoxylated C₁₀ to C₁₄ alcohols, and diethylcyclohexyl sodium sulphosuccinate for improving the penetration of at least one of said active ingredients into the wood, in particular the ligneous parts, of a perennial plant, in particular a fruit tree or the grapevine.

Very particularly, the present invention relates to the use of a bark penetrating agent selected from the group constituted by the fluoro-surfactants, mixtures of phosphate/ethoxylated or propoxylated alcohol, phosphate/ethoxylated C₉ to C₁₁ alcohols and phosphate/ethoxylated C₁₀ to C₁₄ alcohols, and diethylcyclohexyl sodium sulphosuccinate for improving the penetration of tebuconazole and chlorothalonil in the form of solid particles in suspension with median diameter D₅₀ from 0.1 to 1 μm, advantageously from 0.3 to 0.8 μm, in particular from 0.7 to 0.8 μm into the wood, in particular the ligneous parts, of a perennial plant preferably selected from the fruit trees and the grapevine.

The use as described above, of a bark penetrating agent and of solid particles in suspension with a diameter from 0.1 to 1 μm, advantageously from 0.3 to 0.8 μm, in particular from 0.7 to 0.8 μm advantageously makes it possible to improve the penetration of at least one active ingredient to a depth of at least 0.1 mm from the surface of the wood by a factor from 1.5 to 3, in particular by a factor of approximately 2.

The file of this patent contains at least one drawing executed in color. Copies of this patent with color drawings will be provided by the Patent and Trademark Office upon request and payment of the necessary fee.

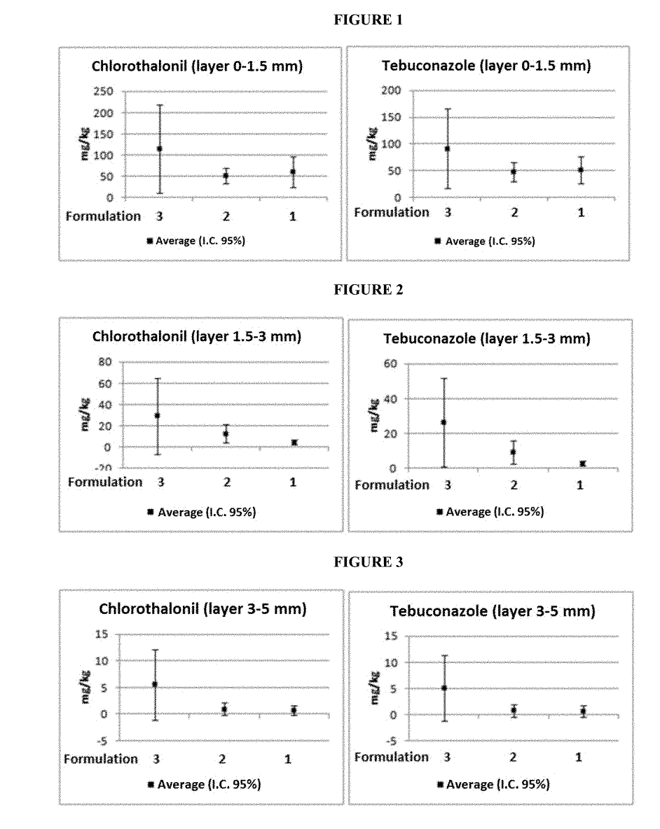

FIGS. 1 to 4 show the results of tests for determining the depth of penetration of the active ingredients into the wood of vine plants with different formulations.

FIG. 1 shows the average quantity of chlorothalonil and tebuconazole measured in the specimens of wood taken at a distance from 0 to 1.5 mm in depth (in mg of active ingredient per kg of wood).

FIG. 2 shows the average quantity of chlorothalonil and tebuconazole measured in the specimens of wood taken at a distance from 1.5 to 3 mm in depth (in mg of active ingredient per kg of wood).

FIG. 3 shows the average quantity of chlorothalonil and tebuconazole measured in the specimens of wood taken at a distance from 3 to 5 mm (in mg of active ingredient per kg of wood).

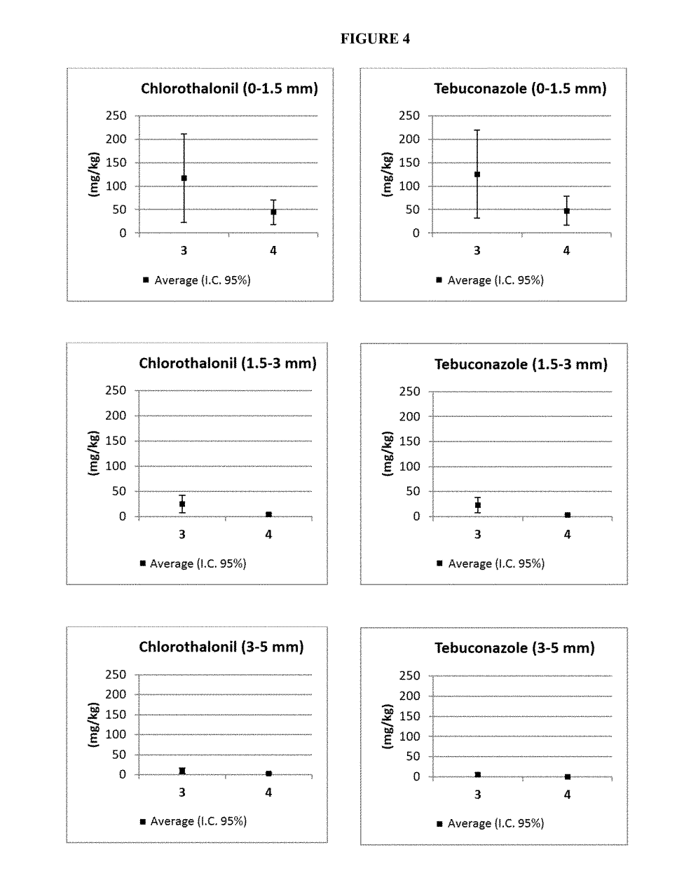

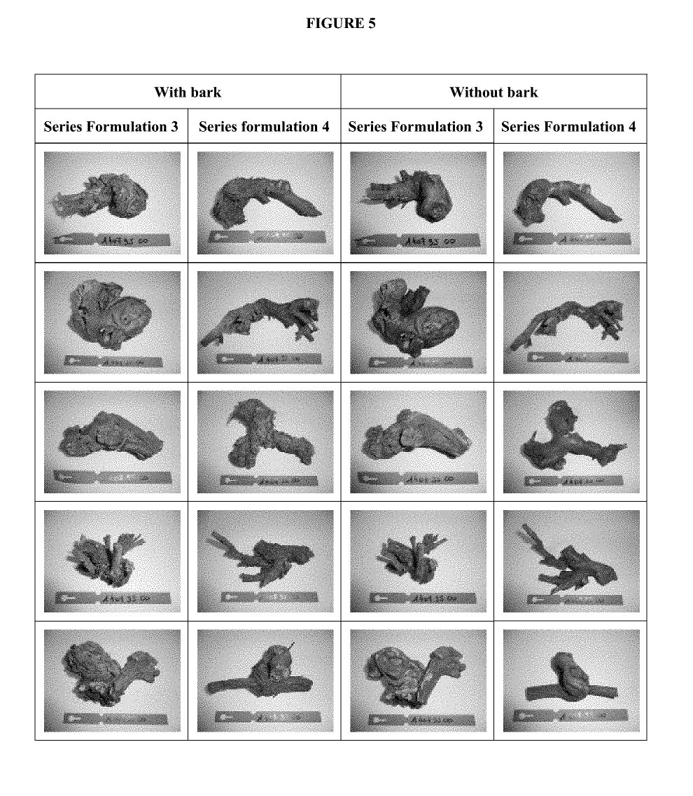

FIG. 4 shows the average quantity of chlorothalonil and tebuconazole measured in the specimens of wood taken at a distance from 0 to 1.5 mm in depth, from 1.5 to 3 mm in depth and at a distance from 3 to 5 mm in depth (in mg of active ingredient per kg of wood).

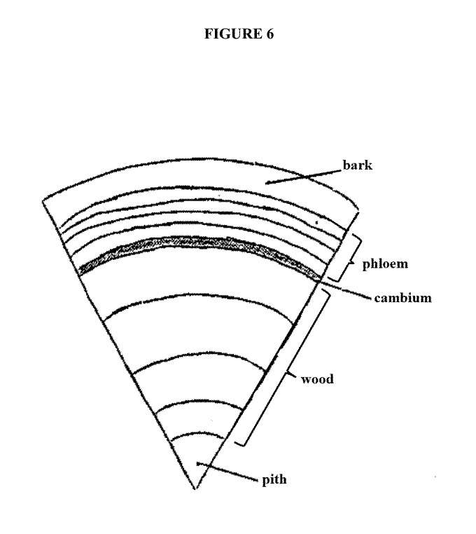

FIG. 5 shows the specimens of grapevines wood used in the tests for determining the depth of penetration of the active ingredients with formulations 3 and 4 into the ligneous parts of vine plants (wood more than one year old) with and without bark.

FIG. 6 shows the structure of the ligneous parts of a perennial plant. This structure occurs in all perennial plants, in particular in the grapevine and in fruit trees such as apple trees, pear trees, peach trees, plum trees and cherry trees.

### EXAMPLES

### Example 1: Determination of the Depth of Penetration of the Active Ingredients

Treatment with various compositions was carried out during the completely dormant period in winter on 15 completely dry vine plants (5 cordons per product) and not during a rainy period.

Application of the phytosanitary composition by spraying was close to the point of runoff.

One week after application of the phytosanitary products, 15 treated specimens were taken (1 piece of old wood per cordon) for analysis.

For each of the 3 series of specimens taken, the protocol for cutting the 5 pieces of old wood was as follows:

1. Brush the specimen to remove the surplus product on the surface.

2. Remove the bark (with a scalpel).

3. Cut (with a saw) “discs” with a width from 2 to 3 cm (variable number of discs depending on the geometry of the specimen).

4. Take (with a microtome) the first 1.5 mm of wood over the whole circumference of the discs=layer A (0 to 1.5 mm).

5. Take (with a microtome) the next 1.5 mm of wood over the whole circumference of the discs=layer B (1.5 to 3 mm).

6. Take (with a microtome) the next 2 mm of wood over the whole circumference of the discs=layer C (3 to 5 mm).

For each of the batches and each of the layers, the active ingredients are extracted from the wood, in particular from the ligneous parts according to the following extraction protocol:

1. Extraction of the whole batch with ethyl acetate by the ASE 100 system (Accelerated Solvent Extraction, Dionex). The extraction conditions are presented in Table 1.

TABLE 1
Conditions for extraction by ASE 100
Extraction conditions by ASE 100

| Parameters | Analytical conditions |
|---|---|
| Solvent | Ethyl acetate |
| Temperature | 90° C. |
| Pressure | 100 bar |
| Initial heating time | 5 minutes |
| Extraction time | 20 minutes |
| Rinse volume | 100% of the cell volume (34 ml) |
| Purge time (nitrogen U) | 90 seconds |

The extract is then evaporated to dryness in a rotary evaporator and is taken up in 2 ml of ethyl acetate.

Two internal standards, 1,2,4,5-tetramethylbenzene and dieldrin, are added to this extract in 2 ml of ethyl acetate for quantification of the quantity of active ingredient.

The specimen thus prepared is analysed by gas chromatography coupled to a mass spectrometer on Clarus® 500 GC-MS equipment from the company Perkin Elmer.

The assay is carried out in SIM (Single Ion Monitoring) mode with one ion for quantification and two “qualifying” ions per compound. Calibration was carried out with solutions containing the 2 internal standards and the 2 active ingredients at different concentrations.

The analytical conditions are presented in Tables 2 and 3.

TABLE 2
parameters of the gas chromatograph
Gas chromatography

| Parameters | Analytical conditions |
|---|---|
| Type of column | Elite-5 ms (60 m × 0.25 mm, 0.25 μm) |
| | (5% diphenyl/95% |
| | dimethylpolysiloxane |
| Carrier gas | Helium |
| Column flow rate | 1.2 ml/min |
| Injection mode | Splitless for 1 minute then leak rate of |
| | 30 ml/min, volume injected 1 μl |
| Injector temperature | 250° C. |
| Temperature | 90° C. for 6 min/90 to 330° C. |
| programming | (15° C./min)/330° C. for 8 min |
| of the oven | |

TABLE 3
parameters of the mass spectrometer
Mass spectrometry

| Parameters | Analytical conditions | |
|---|---|---|
| Mode | Electron ionization (70 eV) | |
| Transfer line temperature | 330° C. | |
| Source temperature | 250° C. | |
| Analysis in scanning mode | Range of m/z ratios scanned: 30 to 350 | |
| | | Ions (m/z) |
| Analyses in SIM (Single | Chlorothalonil | 264/266/268 |
| Ion Monitoring) | | |
| mode | Tebuconazole | 70/125/250 |
| The ions in bold are those | 1,2,4,5- | 91/119/134 |
| adopted for quantification | tetramethylbenzene | |
| | (internal standard 1) | |
| | Dieldrin | 79/81/149 |
| | (internal standard 2) | |

Formulations Tested:

The four formulations presented in Table 4 were tested under the conditions described above.

Formulation 1 is a composition in the form of a concentrated suspension without bark penetrating agent, in which the particles of active ingredients have a median diameter D₅₀ as measured under the conditions of Example 3 of 1.50 μm.

Formulation 2 is a composition in the form of a concentrated suspension without bark penetrating agent, in which the particles of active ingredients have a median diameter D₅₀ as measured under the conditions of Example 3 of 0.77 μm.

Formulation 3 is a composition in the form of a concentrated suspension according to the invention, in which the particles of active ingredients have a median diameter D₅₀ as measured under the conditions of Example 1 of 0.77 μm and which contain a bark penetrating agent.

Formulation 4 is a composition in the form of a concentrated suspension, in which the particles of active ingredients have a median diameter D₅₀ as measured under the conditions of Example 3 of 1.60 μm and which contain a bark penetrating agent.

| | Formulation 1 | | Formulation 2 | | Formulation 3 | | Formulation 4 | |
|---|---|---|---|---|---|---|---|---|
| Active | Chlorothalonil | 20.4% | Chlorothalonil | 20.4% | Chlorothalonil | 20.4% | Chlorothalonil | 20.4% |
| ingredients | Tebuconazole | 20.4% | Tebuconazole | 20.4% | Tebuconazole | 20.4% | Tebuconazole | 20.4% |
| Dispersant | Ethoxylated | 4.96% | Ethoxylated | 4.96% | Ethoxylated | 4.96% | Ethoxylated | 4.96% |
| | alkylphenol | | alkylphenol | | alkylphenol | | alkylphenol | |
| | phosphate | | phosphate | | phosphate | | phosphate | |
| | Sodium | 0.4% | Sodium | 0.4% | Sodium | 0.4% | Sodium | 0.4% |
| | lignosulphate | | lignosulphate | | lignosulphate | | lignosulphate | |
| Antifoaming | Dimethyl- | 0.16% | Dimethyl- | 0.16% | Dimethyl- | 0.16% | Dimethyl- | 0.16% |
| agent | polysiloxane | | polysiloxane | | polysiloxane | | polysiloxane | |
| Bark | — | | — | | Ethoxylated fatty | 0.86% | Ethoxylated fatty | 0.86% |
| penetrating | | | | | alcohol phosphate | | alcohol phosphate | |
| agent | | | | | | | | |
| Thickener | Attapulgite | 0.62% | Attapulgite | 0.62% | Attapulgite | 0.62% | Attapulgite | 0.62% |
| | Heteropoly- | 0.21% | Heteropoly- | 0.21% | Heteropoly- | 0.21% | Heteropoly- | 0.21% |
| | saccharide | | saccharide | | saccharide | | saccharide | |
| Preservative | Benziso- | 0.05% | Benziso- | 0.05% | Benziso- | 0.05% | Benziso- | 0.05% |
| | thiazolidinone | | thiazolidinone | | thiazolidinone | | thiazolidinone | |
| Inert solvent | Monopropylene | 4% | Monopropylene | 4% | Monopropylene | 4% | Monopropylene | 4% |
| | glycol | | glycol | | glycol | | glycol | |
| Water | Water | 48.8% | Water | 48.8% | Water | 47.94% | Water | 47.94% |

| | | | | |
|---|---|---|---|---|
| D₅₀ | 1.50 μm | 0.77 μm | 0.77 μm | 1.60 μm |

Results:

The results of the assays of the active ingredients at different depths are presented in FIGS. 1 to 3.

In the less deep layer (0 to 1.5 mm), formulations 1 and 2 allow penetration of approximately half the quantity of active ingredients in comparison with formulation 3 according to the invention, in which the bark penetrating agent is present.

The size of particles does not have a significant influence on the penetration of the active ingredients when no bark penetrating agent is present in the formulation.

In the middle layer (1.5 to 3 mm thick), the quantity of active ingredients that have penetrated into the wood, in particular the ligneous parts with formulation 3 is nearly twice the quantity of the same active ingredients that have penetrated into the wood, in particular the ligneous parts with formulations 1 and 2.

At this depth, an effect of the size of particles on the penetration of the active ingredients is observed: thus, penetration of chlorothalonil and tebuconazole are favoured by the reduction in size of particles.

In the deepest layer studied (3-5 mm), only formulation 3 according to the present invention allows significant penetration of the active ingredients.

With formulations 1 and 2, the quantity of active ingredients present in this layer is close to 0.

These results thus demonstrate the superiority of the formulations according to the invention that contain a bark penetrating agent and have a median diameter of the particles D₅₀ of less than 1 μm.

### Example 2: Study of the Effect of the Size of Particles in a Formulation Containing a Bark Penetrating Agent

The influence of the size of particles on the penetration of the active ingredients was evaluated in the presence of a bark penetrating agent, by the method described in Example 1.

Comparative formulation 4 has a composition identical to composition 3. However, the size of particles of the active ingredients in formulation 4 is 1.6 μm (versus 0.77 μm for formulation 3).

Results:

The results of the assays of the active ingredients at different depths are presented in FIG. 4.

In the less deep layer (0 to 1.5 mm), the size of particles has a significant influence on the penetration of the active ingredients and formulation 3 allows penetration of double the quantity of active ingredients.

In the middle layer (1.5 to 3 mm thick), the quantity of active ingredients that have penetrated into the wood, in particular the ligneous parts with formulation 3 is much higher than the quantity of active ingredients that penetrated the wood, in particular the ligneous parts with formulation 4.

In the deepest layer studied (3-5 mm), only formulation 3 according to the present invention allows significant penetration of the active ingredients.

These results thus confirm the need for the presence of a bark penetrating agent and for a median diameter of the particles D₅₀ of less than 1 μm.

### Example 3: Determination of the Size of Particles of Active Ingredients

The equipment used in this example is a CILAS 715 laser granulometer.

Principle of the CILAS 715 Granulometer

The presence of particles in a beam of coherent light causes diffraction, which is reflected in the existence of light outside the geographical limits of the beam. The low-power ruby laser provides parallel-beam illumination of a cell containing the sample of particles to be analysed suspended in demineralized water. The beam leaving the cell is focused by a convergent optical system. The distribution of the light energy is then analysed in the focal plane of the system using a multicell detection assembly.

Procedure Start of Manipulation
Click the button “Measurement” and select the analysis procedure (SOP) “Ultrasound 30s”.

Enter the specimen reference (obligatory), the batch number and the operator's initials.
Click the “Measurement while empty” box (the granulometer carries out the measurement while empty).

Introduction of the Specimen and Measurement

At the end of measurement while empty, the program waits for the introduction of the specimen, it is therefore necessary to:
Press the “Real-time signals” button, to cause the indicator of concentration of product to appear (at the bottom of the table).
Introduce the specimen; the concentration must be between 150 and 200. Activate the ultrasound manually during introduction.
Press the “Real-time signals” button again to close this window and release the automatic system to proceed with measurement.
Click the box “Start measurement”.

The median diameter of the particles is calculated directly by the equipment.

### Example 4: Study of the Effect of Tebuconazole, Chlorothalonil and a Tebuconazole/Chlorothalonil Mixture on the Germination of the Spores of Fungi Associated with Diseases of the Wood, in Particular of the Ligneous Parts of the Grapevine

Formulations Studied:

Formulation 3 was used in this experiment and was compared with two formulations 5 and 6, devoid of one of the two active ingredients but of identical composition (the quantity of active ingredient omitted is replaced with water).

Formulation 5 is devoid of tebuconazole.

Formulation 6 is devoid of chlorothalonil.

Preparation of the Spores:

The fungi on which formulations 3, 5 and 6 were tested are Phaemoniella chlamydospora (81pep), Phaeoacremonium aleophilum (LR 23), Diplodia seriata (F98-01), Neofusicoccum parvum (NpSV) and Eutypa lata.

The fungi are transferred to a malt-agar medium (15 g of malt and 20 g of agar per litre of deionized water, sterilized at 120° C. for 20 minutes) in a Petri dish for multiplication.

The conidia of Phaemoniella chlamydospora and Phaeoacremonium aleophilum are obtained from cultures of these fungi. The conidia are obtained by rinsing the colony of fungi with a few millilitres of sterile deionized water.

The suspension of conidia in deionized water is then adjusted to 100-200 conidia per μl.

The conidia of Diplodia seriata are obtained from pycnidia that have developed in less than three weeks of culture on the malt-agar medium. The pycnidia are taken from and cultured in sterile water in such a way that they release the conidia.

The conidia of Neofusicoccum parvum are obtained from pycnidia that have developed on fragments of grapevines shoots.

The ascospores of Eutypa lata are obtained from perithecia situated on vine plants that have died from Eutypiosis. The perithecia are decapitated superficially, isolated one by one and soaked in sterile water for approximately 2 hours. The concentration of ascospores is then adjusted to 100-200 conidia per μl.

Preparation of the Culture Media with and without Fungicide:

The culture medium is a malt-agar medium (15 g of malt and 20 g of agar per litre of deionized water, sterilized at 120° C. for 20 minutes).

The medium containing the fungicides is prepared by diluting the formulation under investigation in deionized water, which is added to the culture medium. The mixture is then homogenized and distributed in Petri dishes with a diameter of 90 mm.

The final concentrations of each active ingredient in the medium are as follows: 0.0005, 0.005, 0.05, 0.5, 5, 50 and 500 mg/L.

100 μl of a previously homogenized suspension of spores is deposited and spread over the surface of the culture medium.

Measurement of the Germination of the Spores:

Two repetitions are carried out for each test.

The percentage germination of the spores is evaluated relative to a control placed under the same conditions.

Two Petri dishes are incubated at 25° C. for a time required for the spores of the control dish to have germinated between 90 and 100%.

For each Petri dish, 200 spores are counted and the percentage of spores germinated is calculated.

For each concentration of fungicide, the percentage efficacy of the active ingredient is determined by the following equation:

$$\% efficacy = 100 \times \frac{\begin{matrix}\% spores \\ germinated \\ on control medium\end{matrix} - \begin{matrix}\% spores \\ germinated \\ on fungicide \\ medium\end{matrix}}{\% spores germinated on control medium}$$

Results:

Phaemoniella chlamydospora:

At concentrations of 0.05 mg/1, chlorothalonil does not inhibit germination of the spores. At the same concentration, tebuconazole alone and the combination of the two active ingredients (0.5 mg each) inhibit germination of the spores completely.

Phaeoacremonium Aleophilum:

Chlorothalonil does not inhibit germination of the spores at the concentrations tested. Tebuconazole does not prevent germination of the spores but inhibits their elongation starting from a concentration of 5 mg/l.

The combination of the two active ingredients inhibits germination of the spores starting from a concentration of 0.1 mg/l.

Diplodia seriata:

Chlorothalonil does not inhibit germination of the spores at the concentrations tested.

Tebuconazole alone and the combination of the two active ingredients inhibit germination of the spores completely starting from a concentration of 0.5 mg/l.

Neofusicoccum parvum:

Chlorothalonil inhibits germination of the spores starting from a concentration of 5 mg/l.

Tebuconazole alone does not inhibit germination of the spores at the concentration tested.

The combination of the two active ingredients (formulation 3) inhibits germination of the spores completely starting from a concentration of 0.5 mg/l of each of the active ingredients.

Eutypa lata:

Chlorothalonil and tebuconazole inhibit germination of the spores at concentrations of 5 and 50 mg/1, respectively.

Inhibition of germination of the spores is complete with formulation 3 starting from 0.5 mg/l of each of the active ingredients in combination.

### Example 5: Study of the Effect of Tebuconazole, Chlorothalonil and of a Tebuconazole/Chlorothalonil Mixture on Mycelial Growth of Fungi Associated with the Wood of the Grapevine

Formulations Studied:

Formulation 3 was used in this experiment and was compared with two formulations 5 and 6, is devoid of one of the two active ingredients but of identical composition (the quantity of active ingredient omitted is replaced with water).

Formulation 5 is devoid of tebuconazole.

Formulation 6 is devoid of chlorothalonil.

Preparation of the Spores:

The fungi on which formulations 3, 5 and 6 were tested are Diplodia seriata (F98-01), Neofusicoccum parvum (NpSV), Eutypa lata (St309) and Formitiporia mediterranea (F2010-1).

Preparation of the Culture Medium with and without Fungicide:

The culture medium is a malt-agar medium (15 g of malt and 20 g of agar per litre of deionized water, sterilized at 120° C. for 20 minutes).

The medium containing the fungicides is prepared by diluting the formulation under investigation in deionized water, which is added to the culture medium. The mixture is then homogenized and distributed in Petri dishes with a diameter of 90 mm.

The final concentrations of each active ingredient in the medium are as follows: 0.0005, 0.005, 0.05, 0.5, 5, 50 and 500 mg/L.

Preparation of the Fungi:

Discs with a diameter of 6 mm, cut out with a punch, are placed in each dish in sterile conditions. Three repetitions are carried out for each test. The Petri dishes are incubated at 25° C. for a time necessary for the fungus to develop as far as 1 or 2 cm from the edges of a Petri dish.

The percentage mycelial growth is evaluated relative to a control placed under the same conditions for each concentration of fungicide, by the following equation:

$$\% efficacy = 100 \times \frac{\begin{matrix}diameter of the \\ control colony\end{matrix} - \begin{matrix}diameter of the \\ colony \\ on fungicide \\ medium\end{matrix}}{diameter of the control colony}$$

Determination of IC50, IC90 and of the Lethal Dose LD 100:

The value of the concentration of the active ingredients required for inhibiting mycelial growth at 50% (IC50) or at 90% (IC90) is calculated from the regression straight line of the percentage efficacy as a function of the logarithm of the concentration of the fungicide.

The value of the concentration of the fungicide that is lethal for the fungus is obtained according to the following methodology; the mycelial implants that have not developed on the culture medium with fungicide are transferred to a malt-agar culture medium, without fungicide. The Petri dishes are then incubated at ambient temperature. Failure of the mycelial implant to take is noted.

Study of Antagonism, Additivity and Synergy of the Active Ingredients in the Combinations of Fungicides:

The interactions between the fungicides in composition 3 are investigated by Wadley's method. IC50 and IC90 can be determined for each fungicide and for the fungicide combination from the curves plotted for each active ingredient used alone or for the combination.

IC90 and the theoretical IC90 for the combination is then calculated using the following equation:

$$\begin{matrix}IC th \\ =\end{matrix} \frac{a + b}{\frac{a}{IC A} + \frac{b}{IC B}}$$

The type and the level of the interaction F are then calculated by dividing the theoretical IC value by the experimental IC observed for the combination of fungicides (F=theoretical IC/experimental IC).

The interactions are defined thus:
Additivity: F=1,
Synergy: F>1,
Antagonism: F<1.

Results:

Eutypa lata:

Tebuconazole inhibits mycelial growth completely starting from a concentration of 0.5 mg/l. Only the concentration of 500 mg/l is lethal.

Chlorothalonil does not display fungicide activity at the concentrations tested but strongly inhibits mycelial development starting from a concentration of 50 mg/l.

The combination of the two fungicides does not make it possible to improve these results and an additivity action between the two fungicides is observed.

Diplodia seriata:

Tebuconazole inhibits mycelial growth completely starting from a concentration of 50 mg/l. Only the concentration of 500 mg/l is lethal.

Chlorothalonil does not display fungicide activity at the concentrations tested but strongly inhibits mycelial development starting from a concentration of 500 mg/l.

The combination of the two fungicides makes it possible to improve these results and a synergy effect between the two fungicides is observed (IC50 of 0.004 versus 0.006 for tebuconazole alone).

Neofusicoccum parvum:

Tebuconazole inhibits mycelial growth completely starting from a concentration of 0.5 mg/l. Only the concentration of 500 mg/l is lethal.

Chlorothalonil does not display fungicide activity at the concentrations tested but strongly inhibits mycelial development at a concentration of 500 mg/l.

The combination of the two fungicides makes it possible to improve these results and a synergy effect between the two fungicides is observed (IC50 of 0.001 versus 0.013 for tebuconazole alone).

Fomitoporia mediterranea:

Tebuconazole inhibits mycelial growth completely starting from a concentration of 0.5 mg/l. None of the concentrations tested is lethal.

Chlorothalonil does not display fungicide activity at the concentrations tested but strongly inhibits mycelial development starting from a concentration of 5 mg/l.

The combination of the two fungicides makes it possible to improve these results and a synergy effect between the two fungicides is observed (IC50 of 0.001 versus 0.003 for tebuconazole alone).

### Conclusions Concerning the Results of Examples 3 and 4

The activity of chlorothalonil and of tebuconazole varies depending on the fungus studied. A synergistic effect between the active ingredients is observed on the germination of the spores of Neofusicoccum parvum, Diplodia seriata and Phaeoacremonium aleophilum and on mycelial growth of Neofusicoccum parvum, Diplodia seriata and Fomitoporia mediterranea.

### Example 6: Study of the Effect of Other Antifungals, Alone or in Mixtures, on Mycelial Growth of Fungi Associated with the Wood of the Grapevine

The efficacy of tetraconazole, cyproconazole alone or in combination with chlorothalonil or metiram zinc on mycelial growth was evaluated under the same conditions as in Example 4.

The efficacy of tebuconazole in combination with another systemic antifungal, metiram zinc, was also evaluated.

Results:

Eutypa lata:

Tetraconazole inhibits mycelial growth completely starting from a concentration of 5 mg/L. The lethal dose of tetraconazole is 50 mg/L.

Cyproconazole inhibits mycelial growth of Eutypa lata completely starting from a concentration of 1 mg/L. The lethal dose of cyproconazole is 10 mg/L.

Metiram zinc and chlorothalonil do not inhibit the mycelial growth of Eutypa lata completely.

Chlorothalonil and metiram zinc have a low activity on the mycelial growth of this fungus.

Combinations:

(a) Tetraconazole

An additivity effect is observed between tetraconazole and chlorothalonil (F₉₀=0.99).

A synergistic action is observed between tetraconazole and metiram zinc (F₉₀=2.72).

(b) Tebuconazole

The combination of tebuconazole and metiram zinc leads to a synergistic action. The lethal dose is reduced to 5 mg/L.

(c) Cyproconazole:

The combination of cyproconazole and chlorothalonil leads to a synergistic effect on mycelial growth.

Diplodia seriata:

Tetraconazole and metiram zinc inhibit mycelial growth completely at a concentration of 500 mg/L.

Cyproconazole and chlorothalonil have a low activity with respect to Diplodia seriata.

Combinations:

(a) Tetraconazole:

A synergistic effect is observed between tetraconazole and chlorothalonil (F₉₀=7.38) and tetraconazole and metiram zinc (F₉₀=10.84).

(b) Tebuconazole

The combination of tebuconazole and metiram zinc leads to a synergistic action (F₉₀=2.75).

(c) Cyproconazole:

The combination of cyproconazole and chlorothalonil leads to a synergistic effect (F₉₀=1.42), but it is less than the effect observed with tebuconazole or tetraconazole.

Neofusicoccum parvum:

Tetraconazole and cyproconazole inhibit mycelial growth completely at a concentration of 500 mg/L.

Chlorothalonil and metiram zinc have a moderate activity on the mycelial growth of this fungus.

Combinations:

(a) Tetraconazole:

A synergistic effect is observed between tetraconazole and chlorothalonil (F₉₀=1.62) and tetraconazole and metiram zinc (F₉₀=4.04).

(b) Tebuconazole

The combination of tebuconazole and metiram zinc leads to a synergistic action (F₉₀=3.77).

(c) Cyproconazole:

The combination of cyproconazole and chlorothalonil leads to a synergistic effect (F₉₀=1.83).

Fomitoporia mediterranea:

Tetraconazole (10 mg/L), cyproconazole (500 mg/L) and metiram zinc (500 mg/L) inhibit mycelial growth completely. They are all fungicidal.

Combinations:

(a) Tetraconazole:

A synergistic effect is observed between tetraconazole and chlorothalonil (F₉₀=3.03).

The combination of tetraconazole and metiram zinc does not show any improvement (F₉₀=0.94).

(b) Tebuconazole

The combination of tebuconazole and metiram zinc leads to an additivity action (F₉₀=1.02).

(c) Cyproconazole:

The combination of cyproconazole and chlorothalonil leads to a synergistic effect (F₉₀=1.58).

Phaeomoniella chlamydospora

Tebuconazole, tetraconazole and cyproconazole inhibit mycelial growth completely at a concentration of 50 mg/L. These three substances are fungicidal at a concentration of 100 mg/L.

Metiram zinc and chlorothalonil inhibit mycelial growth completely at concentrations of 100 mg/L and 500 mg/L, respectively.

Combinations:

(a) Tetraconazole:

A synergistic effect is observed between tetraconazole and chlorothalonil (F₉₀=2.02).

The combination of tetraconazole and metiram zinc has synergistic activity (F₉₀=2.8).

(b) Tebuconazole

The combination of tebuconazole and metiram zinc leads to a slightly antagonistic action (F₉₀=0.91). Fungicide activity is observed at the same concentration as tebuconazole alone.

(c) Cyproconazole:

The combination of cyproconazole and chlorothalonil leads to a synergistic effect (F₉₀=1.58).

Phaeocremonium aleophilum

Tebuconazole, tetraconazole and cyproconazole inhibit mycelial growth completely at a concentration of 50 mg/L. These three substances are fungicidal at a concentration of 100 mg/L.

Metiram zinc and chlorothalonil inhibit mycelial growth completely at concentrations of 100 mg/L and 500 mg/L, respectively.

Combinations:

(a) Tetraconazole:

A synergistic effect is observed between tetraconazole and chlorothalonil (F₉₀=2.02).

The combination of tetraconazole and metiram zinc possesses synergistic activity (F₉₀=2.8).

(b) Tebuconazole

The combination of tebuconazole and metiram zinc leads to a slightly antagonistic action (F₉₀=0.91). Fungicide activity is observed at the same concentration as tebuconazole alone (lethal dose 100 mg/L).

(c) Cyproconazole:

The combination of cyproconazole and chlorothalonil leads to a synergistic effect (F₉₀=1.58).

### Conclusions Concerning the Results of Example 6

Just as for tebuconazole and chlorothalonil or a mixture thereof, efficacy varies depending on the fungus studied.

Most of the combinations of a contact fungicide and a systemic fungicide lead to a synergistic effect on the mycelial growth of the fungi studied. Certain combinations lead to an antagonistic effect (for example tebuconazole/metiram zinc) but fungicide activity is still observable at the same concentrations.

### Example 7: Study of the Effect of the Compositions on the Growth of Pathogens Associated with the Wood of Fruit Trees Phytophthora Spp. and Neonectria galligena

Formulations 3, 5 and 6 were tested under conditions similar to those described in Example 4 on Phytophthora spp. and Neonectria galligena.

The results obtained follow the same trend as that observed in Examples 4 and 5, and formulation 3, comprising both active ingredients, proves effective on the mycelial growth of Phytophthora spp. and Neonectria galligena.

### Example 8: Study of the Effect of Other Antifungals, Alone or in Mixtures, on the Growth of Pathogens Associated with the Wood of Fruit Trees Phytophthora Spp. and Neonectria galligena

For multicellular organisms such as fungi, the nephelometry method is used on sporulating strains (Joubert et al., Laser nephelometry applied in an automated microplate system to study filamentous fungus growth, Biotechniques 48: 399-404, 2010).

The strains are multiplied on suitable agar media in an oven at 20° C., for 8 days before their use, so as to be in their exponential growth phase. The fungal suspension is prepared extemporaneously at a concentration of 1.34 conidia·mL⁻¹ for Pc and 4.44 conidia·mL⁻¹ for Ch.

100 μl of the suspension is used for the tests.

The tests are carried out in 96-well microplates. Doses of 0 ppm, 0.1 ppm, 0.3 ppm, 1 ppm, 3 ppm, 10 ppm, 30 ppm, 100 ppm, 300 ppm, 1000 ppm and 3000 ppm (final concentration of the substance) will be tested per product.

Three technical repetitions are carried out per modality (target species/formulation).

Controls are added per target pathogenic agent: one positive growth control and the products alone at the highest doses.

Nephelometry measurements (RNU) are carried out for 60 h, every 30 minutes and the growth values are measured to study the growth inhibition effect relative to the fungal controls.

a) Phytophthora cactorum

Product A (tebuconazole) strongly inhibits growth of the fungus P. cactorum: the 50% inhibitory concentration (IC50) is around 200 ppm. The 90% inhibitory concentration (IC90) is reached below the dose of 1000 ppm. The lethal dose was not observed.

Product B (chlorothalonil) strongly inhibits growth of the fungus P. cactorum: the 50% inhibitory concentration (IC50) is slightly below 10 ppm. The 90% inhibitory concentration (IC90) is reached at a dose of 1000 ppm. The lethal dose was not observed.

The cumulative effect of the two products was studied.

IC50 and IC90 are reached below 10 and 1000 ppm, as with product B.

b) Neonectria galligena (Cylindrocarpon heteronema)

Product A (tebuconazole) strongly inhibits growth of the fungus Neonectria galligena: IC50 is reached at a concentration of around 230 ppm. IC90 is reached at a concentration of around 800 ppm. The lethal dose is obtained at 1000 ppm.

Product B (chlorothalonil) strongly inhibits growth of the fungus Neonectria galligena: IC50 is reached at approximately 100 ppm. IC90 is reached at around 250 ppm. The lethal dose is obtained starting from 300 ppm.

No cumulative effect of the two products is observed. In fact, IC50 is observed at around 100 ppm; IC90, at around 250 ppm and the lethal dose starting from 300 ppm, as with chlorothalonil alone.

### CONCLUSIONS

Inhibition of growth is certainly observed for the two fungi tested, Phytophthora cactorum and Neonectria galligena. IC50 and IC90 were obtained with respect to both fungal pathogens tested. The lethal dose was only obtained with respect to Neonectria galligena.

In general, chlorothalonil induces quicker inhibition of fungal growth. Tebuconazole leads to a reduction in growth, but at higher doses than chlorothalonil.

The compositions according to the invention are useful for inhibiting the growth of Phytophthora cactorum and Neonectria galligena and therefore for treating crown gall and European canker in fruit trees, such as apple trees.

1. Fungicide composition in the form of a concentrated suspension comprising:
at least two active ingredients in the form of solid particles, the first active ingredient being selected from the penetrating and/or systemic antifungals and the second active ingredient being selected from the contact antifungals,
at least one bark penetrating agent,
the median diameter D₅₀ of the solid particles being from 0.1 to 1 μm, advantageously from 0.3 to 0.8 μm, in particular from 0.7 to 0.8 μm, and
said composition having a depth of penetration of at least one of the active ingredients into the wood, in particular the ligneous parts, of at least 0.1 mm as determined by the method consisting of preparing a composition comprising one or more active ingredients, applying said composition on the wood, in particular the ligneous parts of a plant, taking a specimen from said plant and evaluating the presence of at least one active ingredient at a depth greater than 0.1 mm from the outer surface of the wood, in particular of the ligneous parts.

2. Composition according to claim 1, in which the depth of penetration of the active ingredients is at least 1 mm, advantageously at least 2 mm.

3. Composition according to claim 1, in which at least 75%, advantageously at least 90%, of the solid particles have a diameter of less than 2 μm.

4. Composition according to claim 1, in which the penetrating and/or systemic antifungal is selected from the group constituted by tetraconazole, tebuconazole, cyproconazole, cyprodinil, fenhexamid and fludioxonil.

5. Composition according to claim 4, in which the contact antifungal is selected from chlorothalonil, fluazinam and metiram zinc, in particular chlorothalonil.

6. Composition according to claim 1, in which the bark penetrating agent is selected from the group constituted by organic solvents and surfactants possessing penetrating properties.

7. Composition according to claim 6, in which the bark penetrating agent is selected from the group constituted by the fluoro-surfactants, mixtures of phosphate/ethoxylated or propoxylated alcohol, phosphate/ethoxylated C₉ to C₁₁ alcohols and phosphate/ethoxylated C₁₀ to C₁₄ alcohols, and diethylcyclohexyl sodium sulphosuccinate.

8. Composition according to claim 1, in which the proportion of the bark penetrating agent relative to the total weight of the composition is from 0.1 to 5%, advantageously from 0.5 to 2%, in particular from 0.5 to 1%.

9. Composition according to claim 1, comprising or consisting of, by weight relative to the total weight of the composition:
20 to 30% of tetraconazole, cyproconazole or tebuconazole,
20 to 30% of chlorothalonil, fluazinam or metiram zinc, advantageously chlorothalonil,
0.5 to 2% of a phosphate/fatty alcohol mixture,
2 to 8% of a mixture of phosphate/ethoxylated alkylphenol and sodium lignosulphate,
0.05 to 0.5% of dimethoxypolysiloxane,
0.05 to 0.2% of isobenzothiazolidinone,
0.5 to 1.5% of a thickener, advantageously xanthan gum and attapulgite,
2 to 8% of monopropylene glycol, and
21.3 to 44.6% of water.

10. Dilute suspension comprising a composition in the form of a concentrated suspension as defined in claim 1 and water, in a proportion from 50 to 99% of water relative to the total volume of the dilute suspension.

11. A method for preventing and/or treating diseases of the wood, in particular of the ligneous parts of a perennial plant, the method comprising applying an effective amount of the composition of claim 1.

12. The method of claim 11, when performed for preventing and/or treating at least one disease of the wood, in particular of the ligneous parts of the grapevine belonging to the group constituted by Eutypiosis, Esca, black dead arm (BDA) and Petri disease.

13. The method of claim 11, when performed for preventing and/or treating at least one disease of the wood, in particular of the ligneous parts of fruit trees belonging to the group constituted by crown gall, European canker and fire blight.

14. The method of claim 11, when performed for preventing and/or treating a disease of the wood, in particular of the ligneous parts of grapevines and fruit trees caused by Eutypa lata, Phaeomoniella chlamydospora, Phaeoacremonium aleophilum, Fomitiporia mediterranea, Eutypa lata, Botryospheria spp., Botryospheria spp., Phaeomoniella chlamydospora, Phytophthora spp., Neonectria galligena and Erwinia amylovora.

15. A suspension of at least one active ingredient in the form of solid particles suitable for improving the penetration of the at least one active ingredient into the wood, in particular the ligneous parts, of a perennial plant, in particular selected from fruit trees and the grapevine, the at least one active ingredient having median diameter D₅₀ from 0.1 to 1 μm and of a bark penetrating agent selected from the group constituted by the fluoro-surfactants, mixtures of phosphate/ethoxylated or propoxylated alcohol, phosphate/ethoxylated C₉ to C₁₁ alcohols and phosphate/ethoxylated C₁₀ to C₁₄ alcohols, and diethylcyclohexyl sodium sulphosuccinate.

16. Composition according to claim 1, comprising or consisting of, by weight relative to the total weight of the composition:
20 to 30% of tebuconazole,
20 to 30% of chlorothalonil,
0.5 to 2% of a phosphate/fatty alcohol mixture,
2 to 8% of a mixture of phosphate/ethoxylated alkylphenol and sodium lignosulphate,
0.05 to 0.5% of dimethoxypolysiloxane,
0.05 to 0.2% of isobenzothiazolidinone,
0.5 to 1.5% of a thickener, advantageously xanthan gum and attapulgite,
2 to 8% of monopropylene glycol, and
21.3 to 44.6% of water.

17. The dilute suspension of claim 10, wherein the water is present in a proportion of 90-99% water in proportion to the total volume of the dilute suspension.

18. The suspension of claim 15, wherein the medial diameter D₅₀ is in a range from 0.3 to 0.8 μm.

19. The suspension of claim 15, wherein the medial diameter D₅₀ is in a range from 0.7 to 0.8 μm.

20. The method of claim 11, wherein the method is performed on one or more of grapevines and fruit trees.
